(19) United States
(12) Patent Application Publication
(10) Pub. No.: US 2022/0305812 A1
(43) Pub. Date: Sep. 29, 2022

(54) MEDIUM, CONTAINER, OBJECT-HOLDING CONTAINER, MARKING DEVICE, AND METHOD OF MANUFACTURING CONTAINER

(71) Applicants: Kazuki FUNAHASHI, Kanagawa (JP); Yoichi ICHIKAWA, Kanagawa (JP); Yumiko KISHI, Kanagawa (JP); Hirotoshi NAKAYAMA, Kanagawa (JP); Makoto HINO, Kanagawa (JP); Kazuhiro AKATSU, Kanagawa (JP)

(72) Inventors: Kazuki FUNAHASHI, Kanagawa (JP); Yoichi ICHIKAWA, Kanagawa (JP); Yumiko KISHI, Kanagawa (JP); Hirotoshi NAKAYAMA, Kanagawa (JP); Makoto HINO, Kanagawa (JP); Kazuhiro AKATSU, Kanagawa (JP)

(21) Appl. No.: 17/692,211

(22) Filed: Mar. 11, 2022

(30) Foreign Application Priority Data
Mar. 23, 2021 (JP) 2021-048170

(51) Int. Cl. B41J 11/00; B23K 26/352; B23K 26/18; B41J 3/407

(52) U.S. Cl. CPC B41J 11/0021; B23K 26/352; B23K 26/18; B41J 3/4073; B65D 1/02

(57) ABSTRACT

A medium, a container, an object-holding container, a marking, device, and a method of manufacturing the container. The medium includes an image of design, and the design includes a light color portion and a dark color portion, the light color portion including a light reflecting layer, and the dark color portion including a light attenuation layer The container includes a laser beam source to emit a laser beam, a forming unit to make the laser beam perform marking on a container that has transparency and is colorless or colored, and an adjuster to adjust a marking condition according to information about a to-lie-contained object stored in the container. The method includes irradiating the container with a laser beam to form a light reflecting layer and a light attenuation layer, and the light reflecting layer and the light attenuation layer includes an aggregate of microstructures.

### CROSS-REFERENCE TO RELATED APPLICATION

This patent application is based on and claims priority pursuant to 35 U.S.C. § 119(a) to Japanese Patent Application No. 2021-048170, filed on Mar. 23, 2021, in the Japan Patent Office, the entire disclosure of which is hereby incorporated by reference herein.

### BACKGROUND

### Technical Field

Embodiments of the present disclosure relate to a medium, a container, an object-holding container, a marking device, and a method of manufacturing the container.

### Background Art

In the related art, a medium on which an identification code such as a bar code and a two-dimensional code, or a design such as a character, a symbol and a mark are marked is known.

Technologies are known in the art in which three steps are performed as follows. In the first step, a film or an attachment is formed on the surface of a material to be marked. The material to be marked is composed of a transparent material or a laser-beam transmissive material. In the second step, the film or the attachment is irradiated with a laser beam, and the film or the attachment is removed from the material to be marked. In the course of these processes of the second step, bumps and dips like a frosted glass are formed on the surface of the material to be marked, in the third step to be performed between the first step and the second step, the film or the attachment is formed in patterns of, for example, a character, a figure, a symbol, a bar code, and a two-dimensional code.

### SUMMARY

Embodiments of the present disclosure described herein provide a medium, a container, an object-holding container, a marking device, and a method of manufacturing the container. The medium includes an image of design, and the design includes a light color portion and a dark color portion, the light color portion including a light reflecting layer, and the dark color portion including a attenuation layer. The container includes a laser beam source configured to emit a laser beam, a forming unit configured to make the laser beam perform marking on a container that has transparency and is colorless or colored, and an adjuster configured to adjust a marking condition according to information about a to-be-contained object stored in the container. The method includes irradiating the container with a laser beam to form a light reflecting layer and a light attenuation layer, and the light reflecting layer and the light attenuation layer includes an aggregate of microstructures. In the irradiating, a condition for formation when the light reflecting layer is to be formed is made different from a condition for formation when the light attenuation layer is to be formed.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating a configuration or structure of a container according to an embodiment of the present disclosure.

FIG. 2A and FIG. 2B are diagrams each illustrating, a configuration of a bar code according to a first embodiment of the present disclosure.

FIG. 2A is a front view of a bar code according to the first embodiment of the present disclosure, and

FIG. 2B is a sectional view of the bar code, which is taken along a cut line A-A of FIG. 1, according to the first embodiment of the present disclosure.

FIG. 3 is a sectional view of the light reflecting layer, illustrating how a light is reflected by the light reflecting layer, according to an embodiment of the present disclosure.

FIG. 4 is a sectional view of a light attenuation layer, illustrating how a light is attenuated by the light attenuation layer, according to an embodiment, of the present disclosure.

FIG. 5 is a sectional view of a polyethylene terephthalate (PET) bottle, illustrating a configuration or structure of the PET bottle, according to a second embodiment of the present disclosure.

FIG. 6A, FIG. 6B, FIG. 6C, and FIG. 6D are sectional views of a light reflecting layer, which are used to illustrate the microstructure of the light reflecting layer, according to the first embodiment of the present disclosure.

FIG. 6A is a sectional view of the microstructure of a light reflecting layer, according to a first case of the first embodiment of the present disclosure.

FIG. 6B is a sectional view of the microstructure of a light reflecting layer, according to a second case of the first embodiment of the present disclosure.

FIG. 6C is a sectional view of the microstructure of a light reflecting layer, according to a third case of the first embodiment of the present disclosure.

FIG. 6D is a sectional view of the microstructure of a light reflecting layer, according to a fourth case of the fast embodiment of the present disclosure.

FIG. 7 is a diagram illustrating a bar code according to a first modification of the second embodiment of the present disclosure.

FIG. 8 is a diagram illustrating a prism array according to a second modification of the second embodiment of the present disclosure.

FIG. 9 is a diagram illustrating a configuration of a marking device according to an embodiment of the present disclosure.

FIG. 10 is a flowchart of the processes in a marking method, according to an embodiment of the present disclosure.

FIG. 11A and FIG. 11B are diagrams each illustrating a configuration or structure of a light reflecting layer according to the first embodiment of the present disclosure.

FIG. 11A is a front view of a light reflecting layer according to the first embodiment of the present disclosure.

FIG. 11B is a sectional view of a light reflecting layer taken along a cut line C-C of FIG. 11A, according to the first embodiment of the present disclosure.

FIG. 12A and FIG. 12B are diagrams each illustrating the flow of the procedure for forming a bar code on a polyethylene terephthalate (PET) bottle, according to a first case of an embodiment of the present disclosure.

FIG. 12A is a sectional view of a light reflecting layer according to an embodiment of the present disclosure.

FIG. 12B is a sectional view of a light attenuation layer according to an embodiment of the present disclosure.

FIG. 13A and FIG. 13B are diagrams each illustrating the flow of the procedure for forming a bar code on a PET bottle, according to a second case of an embodiment of the present disclosure.

FIG. 13A is a sectional view of a light reflecting layer according to an embodiment of the present disclosure.

FIG. 13B is a sectional view of a light attenuation layer according to an embodiment of the present disclosure.

FIG. 14 is a flowchart of the processes in a marking method, according to an alternative embodiment of the present disclosure.

FIG. 15A and FIG. 15B are diagrams each illustrating the flow of the procedure for forming a bar code on a PET bottle, according to a third case of an embodiment of the present disclosure.

FIG. 15A is a sectional view of a light reflecting layer according to an embodiment of the present disclosure.

FIG. 15B is a sectional view of a light attenuation layer according to an embodiment of the present disclosure.

FIG. 16 is a block diagram of a functional configuration of a controller included in the marking device, according to a third embodiment of the present disclosure.

FIG. 17 is a diagram illustrating a configuration or structure of an image formed by a marking device, according to an embodiment of the present disclosure.

FIG. 18A, FIG. 18B, and FIG. 18C are diagrams each illustrating a configuration or structure of an image formed by a marking device, according to an embodiment of the present disclosure.

FIG. 18A is a diagram illustrating an image formed by a marking device, according to a first case of an embodiment of the present disclosure.

FIG. 18B is a diagram illustrating an image formed by a marking device, according to a second case of an embodiment of the present disclosure.

FIG. 18C is a diagram illustrating an image formed by a marking device, according to a third case of an embodiment of the present disclosure.

FIG. 19 is a flowchart of the processes performed by a marking device, according to an embodiment of the present disclosure.

FIG. 20 is a diagram illustrating a look up table (LUT) according, to an embodiment of the present disclosure.

FIG. 21A and FIG. 21B are diagrams each illustrating the amount of filling material such as the amount of to-be-contained object, according to the third embodiment of the present disclosure.

FIG. 21A is a diagram illustrating the amount of filling material such as the amount of to-be-contained object, according to a first case of the third embodiment of the present disclosure.

FIG. 21B is a diagram illustrating the amount of filling material such as the amount of to-be-contained object, according to a second case of the third embodiment of the present disclosure.

FIG. 22A and FIG. 22B are diagrams each illustrating the amount of filling material such as the amount of to-be-contained object, according to the third embodiment of the present disclosure.

FIG. 22A is a diagram illustrating the amount of filling material such as the amount of to-be-contained object, according to a third case of the third embodiment of the present disclosure.

FIG. 22B is a diagram illustrating the amount of filling material such as the amount of to-be-contained object, according to a fourth case of the third embodiment of the present disclosure.

FIG. 23A, FIG. 23B, and FIG. 23C are diagrams illustrating a bar code according to an embodiment of the present disclosure.

FIG. 23A is a diagram illustrating a schematic configuration of a bar code according to an embodiment of the present disclosure.

FIG. 23B is a diagram illustrating a magnified image of an area in FIG. 23A, according to a first case of the present embodiment.

FIG. 23C is a diagram illustrating a magnified image of a region in FIG. 23A, according to a second case of an embodiment of the present disclosure.

FIG. 24A and FIG. 24B are diagrams illustrating a polyethylene terephthalate (PET) bottle before and after a to-be-contained object is consumed, according to an embodiment of the present disclosure.

FIG. 24A is a diagram illustrating a PET bottle before the to-be-contained object is consumed, according to an embodiment of the present disclosure.

FIG. 24B is a diagram illustrating a PET bottle after the to-be-contained object is consumed, according to an embodiment of the present disclosure.

FIG. 25 is a diagram illustrating a configuration of a manufacturing line according to an embodiment of the present disclosure.

FIG. 26 is a block diagram of a functional configuration of a controller included in the marking, device, according to a first modification of the third embodiment of the present disclosure.

FIG. 27 is a block diagram of a functional configuration of a controller included in the marking device, according to a second modification of the third embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to he limiting of the present disclosure. As used herein, the singular forms “a”, “an” and “the” are intended to include the plural forms as well, unless the context clearly indicates otherwise. it will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure are described below with reference to the accompanying drawings.

In the drawings, like reference signs denote like elements, and overlapping description may be omitted.

A medium, a container, an object-holding container, a marking device, and a method of manufacturing the container according to embodiments of the present disclosure are described below to implement the technical ideas, and no limitation is indicated to the embodiments of the present disclosure given below. For example, the size, material, and shape of components and the relative positions of the arranged components are given by way of example in the following description, and the scope of the present disclosure is not limited thereto unless particularly specified. For example, the size of these elements and the relative positions of these elements may be exaggerated for purposes of illustration in the drawings.

The medium according to the present embodiment is a medium that has a design thereon, and the design may include, for example, as light attenuation layer or a light reflecting layer. The medium includes a container in which the design is formed on at least one of the outer surfaces of the base material or on the inner surfaces of the base material.

On the surface of a medium such as a container as typified by a PET bottle, the information about, for example, a name, an identification number, a manufacturer, and a date of manufacture of the medium itself or of a to-be-contained object needs to be displayed. For this reason, a medium on which an identification code such as a bar code and a two-dimensional code, and various kinds of design such as a character, a symbol, and a mark are marked is used in the related art.

The container refers to a member capable of containing a substance such as a solid, liquid, and gas therein. The container may include, for example, a cap and a lid in addition to a main body that contains a to-be-contained object. The container that contains a to-be-contained object such as beverages may be referred to as an object-holding container in the description of the present disclosure. The to-be-contained object is, for example, a beverage. The substance that makes up the container may be referred to as a base material in the description of the present disclosure. The container may be configured by a transparent material such as resin or glass.

Such a transparent material refers to a material having optical transparency to at least visible light. Visible light refers to light that can be visually recognized by human, where the lower bound of wavelength ranges from approximately 360 milometers (nm) to approximately 400 am and the upper bound of wavelength ranges from approximately 760 nm to approximately 830 nm.

The resin material may be, for example, a material including polyethylene terephthalate (PET), polyvinyl alcohol (PVA), polybutylene adipate terephthalate (PBAT), polyethylene terephthalate succinate, polyethylene (PE) polypropylene (PP), polyvinyl chloride (PVC), polystyrene (PS), polyurethane, epoxy, bio polybutylene succinate (PBS), polylactic acid blend (PBAT), starch-blended polyester resins, polybutylene terephthalate succinate, polylactic acid (PLA), polyhydroxy butyrate/ hydroxy hexanoate (PHBH), polyhydroxy alkanoic acids (PHA), bio PET 30, bio polyamide (PA) 610, 410, and 510, bio PA 1012, 10T, bio PA 11T and MXD-10, bio polycarbonate, bio polyurethane (PE), bio PET 100, bio PA 11, and Bio PA 1010.

The design is an object to which information is added, and the design is disposed on the medium. For example, the medium includes an identification code, characters, symbols, and marks. Such an identification code includes, for example, a one-dimensional code such as a bar code or a two-dimensional code such as a quick response (QR) code (registered trademark). What is indicated by an identification code may be a symbol, a figure, or a character that indicates a container to which an identification code is added, the name or identification number of an object such as a to-be-contained object contained in the container, or the object information such as the manufacturer and the date and time of manufacture.

The design includes a light color portion represented by a bright color such as white and a dark color portion represented by a dark color such as black. As the design is read by a dedicated reader, what is indicated by the design can be obtained. For example, a black portion in the expression of a typical bar code corresponds to a dark color portion, and a white portion corresponds to a light color portion.

A medium such as a polyethylene terephthalate (PET) bottle is used in a wide range of applications because it has various kinds of desirable functionality such as preservability and hermeticity. However, currently, environmental problems such as plastic wastes in the ocean associated with an increase in the amount of plastics used are widely discussed, and there has been a global active movement to reduce the environmental pollution caused by plastic wastes. For this reason, recycling for environmental protection has been advanced, and after the to-be-contained object is consumed by a consumer, the medium is collected and recycled. The importance of the activities of recycling concerns not only plastics, but also concerns, for example, glass in a similar manner.

In the related art, typically, a separately prepared recording medium such as a label is pasted in order to add a design to the medium such as a polyethylene terephthalate (PET) bottle. On such a label, for example, information to be viewed by a consumer such as a product name, nutrition facts, a best before date, a bar code, a two-dimensional code, a recycle mark, or a logo mark, and a designed image or an illustration used to appeal features of the product to a consumer are displayed. The label is attached for the management and sales promotion of the product. However, in many cases, the base material of the medium and the label are made of different materials. For this reason, the base material of the medium and the label need to be separated from each other in the recycling process. Accordingly, in recycling, an operation of manually peeling the label from the bottle is required at the time of collection, and excessive waste whose amount correlates with the amount of peeled label is elected.

Currently, a PET bottle beverage without a label is sold as a so-called labelless product. Such a litheness product is manufactured using a method as follows. In such a method, the minimum necessary information of a container such as a recycle mark is marked using a die or mold at the time of molding, and for example, the nutrition facts are printed on a box in which containers are packaged. However, such a product can only be sold in a unit of box, and the type of product to which the above method can be applied is limited. If what is indicated by the label can be displayed above the base material of the body of the medium, in a wider mime of products, the amount of waste that correlates with the peeled label can be educed, and the recycling steps can be simplified.

As a method of forming a design such as a label on a base material, a method of drawing the design by irradiating the base material with a laser beam is known in the art. In such a method, no additional material other than the medium is adhered to the medium. Accordingly, recyclability can be improved. However, as the non-processed portion is transparent, the readability of the drawn design changes greatly due to, for example, the ambient brightness. For this reason, the robustness of the display cannot be sufficiently ensured.

As a method of forming an image on the base material, printing may directly be performed on the base material using a coloring material such as ink. However, the added coloring material cannot be sufficiently removed in the recycling steps. Accordingly, in such cases, recycling of materials may become too difficult.

For example, the council for PET bottle recycling provides a guideline that direct printing on PET bottles using a coloring material containing a non-recyclable material is not to be performed because the demands for high-quality recycling are particularly high for PET bottles.

In the above guideline, printing using a small amount of ink or the like to display, for example, a best before date, a factory identifying mark, or a lot number is excluded. However, a design that is handled in the embodiments of the present disclosure such as a Japanese Article Number (JAN) code, which is one of the bar codes widely used for all types of commodities, has a standard size of 37.92 millimeters (mm)×25.93 mm, and a coloring material tends to be adhered to a wide area of the medium by direct printing. Accordingly, the recyclability is affected.

In the present embodiment, a dark color portion is configured so as to include the light attenuation layer itself or to implement the transmission-preventing effect of the light attenuation layer. When the transmission-preventing effect of the light attenuation layer is implemented, the transmission-preventing effect is implemented in the transparent non-processed portion.

The light reflecting layer is included in the light color portion of the design. On the region where the light reflecting layer 31 is formed, the incident light from a reader is diffusely reflected in varying directions.

The light color portion on the design is made visually recognized due to the light reflected by the light reflecting layer, and a region where the light is attenuated by the light attenuation layer is made visually recognized as the dark color portion of an identification code. By so doing, the signal contrast that indicates the difference in radiation intensity of light between the light from a light color portion and the light from a dark color portion can be enhanced, and the readability of an identification code can he improved.

Some embodiments of the present disclosure are described below in detail with reference to the accompanying drawings.

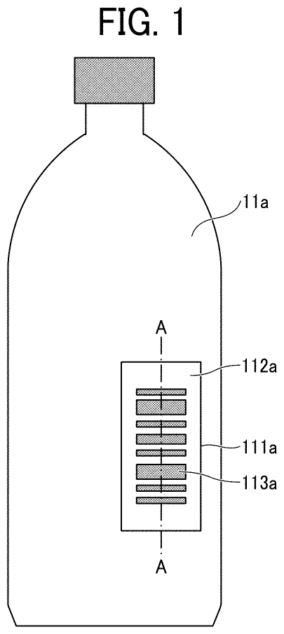

FIG. 1 is a diagram illustrating a configuration or structure of a PET bottle 11a, according to an embodiment of the present disclosure.

The PET bottle 11a that serves as a medium is a container containing a transparent resin material. As illustrated in FIG. 1, the PET bottle 11a has a bar code 111a thereon. On the bar code 111a, linear patterns are arranged in a direction approximately orthogonal to a direction in which the linear patterns extend.

The bar code 111a according to the present embodiment is a design that serves as an identification code including a light color portion 112a represented by a bright color such as white and a dark color portion 113a represented by a dark color such as black. The bar code 111a according to the present embodiment includes a space region of the light color portion 112a and a bar region of the dark color portion 113a. In FIG. 1, a bar code is given by way of example to describe an embodiment of the present disclosure, but no limitation is indicated thereby. For example, when a white character is drawn as iteration on the background image in black, the background image serves as a dark color portion, and the character portion serves as a light color portion. The definition of colors such as black and white is not given in the description of the present disclosure to limit the configuration or structure of the design, but is given to describe, in a simplified manner, the relation in variations of light and shade between a light color portion and a dark color portion in the design. For example, the information about the PET bottle 11a or the contents (11a, 270a) such as the name, identification number, manufacturer, date and time of manufacture of the PET bottle 270b or the to-be-contained object such as beverage contained in the PET bottle 11a is displayed.

In the case of a container such as a polyethylene terephthalate (PET) bottle, a bar code may be displayed by pasting a recording medium such as a label on which an identification code is recorded to the container. By contrast, in the present embodiment, a pattern that indicates the bar code 111a is formed on the base material that makes up the PET bottle 11a. As a result, the bar code 111a can be displayed in a so-called labelless manner without using the recording medium.

### First Embodiment

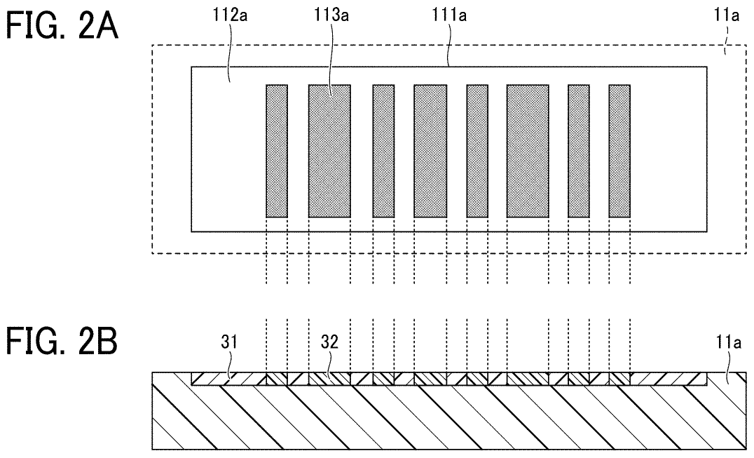

The PET bottle 11a according to a first embodiment of the present disclosure is described below with reference to FIG. 2A to FIG. 4.

FIG. 2A and FIG. 2B are diagrams each illustrating a configuration or structure of a bar code 111a according to the present embodiment.

More specifically, FIG. 2A is a front view of the bar code 111a according to the present embodiment, and FIG. 2B is a sectional view of the bar code 111a, which is taken along a cut line A-A of FIG. 1. As illustrated in FIG. 2A and FIG. 2B, the light color portion 112a of the design includes a light reflecting layer 31, and the dark color portion 113a includes a light attenuation layer 32.

The light reflecting layer 31 is a layer that includes an aggregate of microstructures and reflects light by the aggregate of microstructures.

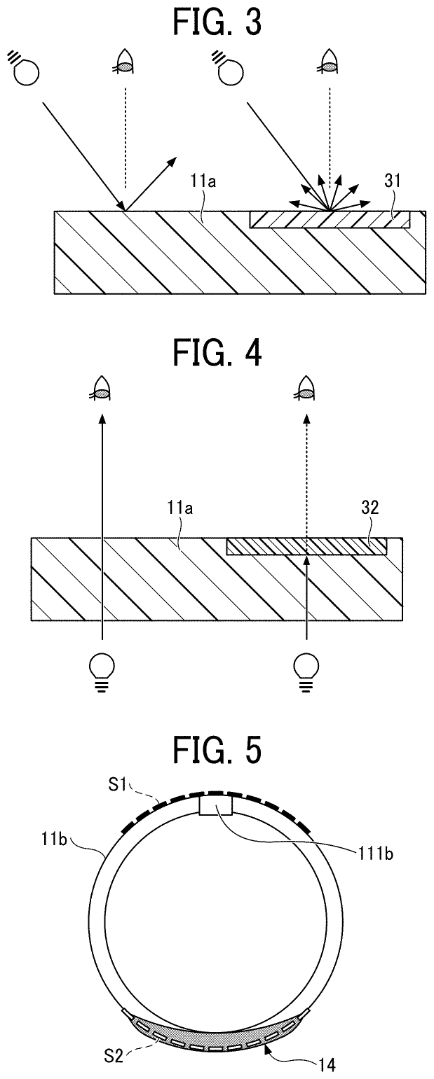

FIG. 3 is a sectional view of the light reflecting layer 31, illustrating how the light is reflected by the light reflecting layer 31, according to the present embodiment.

In a region where the light reflecting layer 31 is not formed on the base material of the PET bottle 11a, a light is not diffusely reflected, and an incident light is specularly reflected or transmitted. In the present embodiment, even if a light is not diffusely reflected, a resultant state indicates a state of a typical transparent material, and does not indicate that there is no diffuse reflection component at all.

The reflection light cannot visually be recognized in directions other than the direction in which the light is specularly reflected, and the transmission light cannot visually be recognized in directions other than the direction in which the light is transmitted. Accordingly, the brightness that is required for the light color portion 112a cannot appropriately be expressed. On the other hand, on the region where the light reflecting layer 31 is formed, an incident light is diffusely reflected in varying directions. Accordingly, the reflection light can visually be recognized from varying directions, and the brightness that is required for the light color portion 112a can appropriately be expressed.

In other words, the light reflecting layer 31 has such functions as expressed in a first equation given below.

Lr′>Lr First Equation

Assuming that a light with radiation intensity of light L is uniformly incident on the medium, Lr denotes the radiation intensity of light of the light reflected by the non-display portion of the design, and Lt denotes the radiation intensity of the transmitted light. Lr′ denotes the radiation intensity of light of the light reflected by the light reflecting layer 31, where the reflection includes both specular reflection and diffuse reflection, and Lt′ denotes the radiation intensity of the transmitted light.

FIG. 4 is a sectional view of how a light is attenuated by the light attenuation layer 32, according to the present embodiment.

For example, the light attenuation layer 32 can be formed by irradiating the base material of the PET bottle 11a with a laser beam to alter the quality of the base material. Such an alteration of the quality of the base material is, for example, oxidation or carbonization. In a region where the light attenuation layer 32 is not formed, as the base material has transparency, most of incident light is transmitted. Accordingly, when the bar code 111a is read under bright environments in which the area around is bright, the radiation intensity of visually-recognizable is strong even in the dark color portion 113a, and the degree of darkness required for the dark color portion 113a cannot successfully be expressed. On the other hand, in the dark color portion 113a including the light attenuation layer 32, the transmitted light is attenuated by the light attenuation layer 32. Accordingly, even when the bar code 111a is read under bright environments in which the area around is bright, the radiation intensity of visually-recognizable is weak, and a dark color can successfully be expressed.

In other words, the light attenuation layer 32 can be expressed in a second equation given below.

Lt″<Lt Second Equation

Assuming that a light with radiation intensity of light L is uniformly incident on the medium, Lr denotes the radiation intensity of light of the light reflected by the non-display portion of the design, and Lt denotes the radiation intensity of the transmitted light. Moreover, Lr″ denotes the radiation intensity of light of the light reflected by the light attenuation layer, where the reflection includes both specular reflection and diffuse reflection, and Lt′ denotes the radiation intensity of light of the transmitted light.

The area in which the light reflecting layer 31 diffusely reflects the light becomes further brightened, and the recognizability of the light color portion of the design improves. The area in which the light attenuation layer 32 has attenuated the light becomes further darkened, and the recognizability of the dark color portion of the design improves.

In other words, the comparison between the light reflecting layer 31 and the light attenuation layer 32 can be expressed in a third equation given below.

(Lr′+Lt′)>(Lr″+Lt″) Third Equation

Lr′ denotes the radiation intensity of light of the light reflected by the light reflecting layer 31, where the reflection includes both specular reflection and diffuse reflection, and Lt″ denotes the radiation intensity of the transmitted light. Moreover, Lr″ denotes the radiation intensity of light of the light reflected by the light attenuation layer, where the reflection includes both specular reflection and diffuse reflection, and Lt′ denotes the radiation intensity of the transmitted light.

As described above, by making at least one of the light attenuation layer and the light reflecting layer be included in the design of the medium, the signal contrast that indicates the difference in radiation intensity of light between the light from a light color portion and the light from a dark color portion can be enhanced. In particular, the readability of the design can be improved. In particular, in view of the bar code that requires high contrast, the difference in the amount of signal between the light from the light color portion of the design and the light from the dark color portion of the design can be made equal to or greater than 30% as the reflectivity, due to the effect of the light reflecting layer and the light attenuation layer. As a result, the bar code 111a so can be read stably and accurately even when a reader for the bar code 111a or an environment for reading changes.

Some advantageous effects of the PET bottle 11a are described below.

When an identification code is formed on a medium such as a PET bottle which is transparent and required to be recycled, there is room for improvement in compatibility between readability of the identification code and recyclability of a material constituting the medium. Further, there is room for improvement in the cost of the medium.

More specifically, the identification code is required to be able to stably read information indicated by the identification code when the identification code is read by a reader. In particular, when the signal contrast between the dark color portion and the light color portion of the identification code is low, there are some cases in which the data indicated by the identification code cannot be read or may be erroneously read. Accordingly, the degree of signal contrast has to be increased.

Further, in recycling of materials, it is required that materials other than the material to be recycled are not contained or adhered thereto. Currently, for example, the council for PET bottle recycling provides a guideline that direct printing on PET bottles using a coloring material containing a non-recyclable material is not to be performed because the demands for high-quality recycling are particularly high for PET bottles. Note that in the above guideline, printing using a small amount of ink or the like to display, for example, a best before date, a factory identifying mark, or a lot number is excluded.

When a lot of materials other than the material to be recycled are contained in or adhered to the PET bottle, these materials cannot be sufficiently removed in the recycling step. Accordingly, in such cases, recycling of materials may become too difficult.

For example, when an identification code is formed on the PET bottle 11a by applying a coloring material such as ink, the readability of the identification code is good. However, as a coloring material that contains a material that is not suitable for recycling is adhered to the PET bottle 11a, the recyclability of the material may decrease.

For example, a Japanese Article Number (JAN) code, which is one of the bar codes widely used for all types of commodities, has a standard size of 37.92 millimeters (mm)×25.93 mm. When a bar that serves as a dark color portion and a space that serves as a light color portion of a JAN code are expressed using a coloring material, the coloring material is adhered to a wide area that makes up an identification code. Accordingly, the recyclability is further affected.

When an identification code is formed on a PET bottle using the irradiation with a laser beam, the recyclability of the material is high, but the non-processed portion remains transparent. For this reason, there are some cases in which the signal contrast necessary for reading operation with respect to the ambient brightness cannot be obtained and the readability of the identification code decreases.

For example, when the background of a PET bottle is in a bright color such as while, the entirety of the light color portion and the dark color portion is brightened. In particular, the dark color portion tends to be in a bright color. As a result, the signal contrast between the dark color portion and the light color portion of the identification code gets low, and the readability deteriorates.

By contrast, the PET bottle 11a according to the present embodiment that serves as a container has a bar code 111a that serves as an identification code, and the bar code 111a includes a light color portion 102a and a dark color portion 103a. The light color portion 102a includes a light reflecting layer 31a, and the dark color portion 103a includes a light attenuation layer 32a.

The light reflecting layer 31a includes an aggregate of microstructures. The microstructures include at least one of a concave or recesses formed as a part of the PET bottle 11a is melted or evaporated, a crystallized structure thrilled by crystallizing a part of the PET bottle 11a, and a foamed structure formed as a pan of the PET bottle 11a foams.

In the light color portion 102a, light is reflected by an aggregate of microstructures included in the light reflecting layer 31a, and thus a bright color can be expressed. Further, in the dark color portion 103a, the light attenuation layer 32a attenuates the ambient light around. Accordingly, a dark color can be expressed. As a result, the identification code can be read with high readability regardless of the surrounding environment.

Further, in the present embodiment, each of the light reflecting layer 102a in the light color portion 31a and the light attenuation layer 103a in the dark color portion 32a is formed by irradiating the pulsed laser beam 101L. As a result, materials other than the material to be recycled are not contained in or adhered to the PET bottle 11a. Accordingly, high recyclability can be ensured.

As described above, according to the present embodiment, the readability of the 111a of the bar code can be improved, and the recyclability of the material can be ensured. As the processes of forming the light reflecting layer and the light attenuation layer are relatively simple, the cost of the medium can be reduced.

In the present embodiment, the light attenuation layer 32a of the dark color portion 103a is formed by making use of the alteration of the quality of the base material that makes up the PET bottle 11a, which is caused by the irradiation with the pulsed laser beam 101L. However, no limitation is intended thereby. The light attenuation layer 32a may be formed by applying a coloring material such as ink to the PET bottle 11a. For example, by applying a coloring material such as black ink having a high light attenuating rate, the light attenuation layer 32a is formed, and high readability can be ensured.

By limiting the region to which the coloring material is applied in the PET bottle 11a to only the dark color portion 103a, the amount of coloring-material usage can be reduced compared to a case where the entire bar code 111a is formed of the coloring material, and high recyclability can be ensured.

Even if the coloring material is applied to the light attenuation layer, the superiority to reduce the cost of the medium is maintained because the processes of forming the light reflecting layer is relatively simple.

In the present embodiment, at least some of the light reflecting layer 31a and the light attenuation layer 32a may be formed so as to overlap each other. As a result, the occurrence of a region in which an aggregate of microstructures is not formed can be prevented, and a decrease in readability can also be prevented.

When the difference between the reflectivity of the light reflecting layer 31a and the reflectivity of the light attenuation layer 32a is 30% or more, the bar code 111a can be read stably and accurately even when a reader for the bar code 111a or an environment for reading changes.

As the degree of surface roughness of a substrate is greater, the degree of diffuse reflection on the surface of the substrate increases. Accordingly, when the degree of surface roughness of the light reflecting layer 31a is made greater than that of the light attenuation layer 32a, the contrast of signals between the light color portion 102a and the dark color portion 103a can further be enhanced.

Further, in the present embodiment, the light attenuation layer 32a is at least one of a layer in which the PET bottle 11a is deteriorated or a layer to which a coloring material is applied. For example, the altered layer is an oxidized layer of the substrate or a carbonized layer of the substrate. As a result, good light attenuation properties can be ensured.

In the present embodiment, the PET bottle 11a is irradiated with the pulsed laser beam 101L, and a step of forming the light reflecting layer 31a and the light attenuation layer 32a that include an aggregate of microstructures is performed. In such a step of forming the layers, the conditions for formation are made different from each other between when the light reflecting layer 31a is to be formed and when the light attenuation layer 32a is to be formed.

Due to such a configuration, the structure of the layer of the light reflecting layer 31a can be made different from the structure of the light attenuation layer 32a.

For example, the conditions for formation include a focal point of the pulsed laser beam 101L. The base material is irradiated with the pulsed laser beam 101L that is, for example, defocused and shifted from the focal point in the irradiation direction to apply heat energy to the base material. By so doing, an oxidized or carbonized layer can be formed on the surface of the base material to from the light attenuation layer 32.

### Second Embodiment

A medium according to a second embodiment of the present disclosure is described below. In view of the first embodiment of the present disclosure as described above, like reference signs denote like elements, and redundant description may be omitted where appropriate. The same applies to the embodiments of the present disclosure and the modifications thereof as will be described below.

As described above, the medium according to the present embodiment includes the first side and the second side which is a side other than the first side, the design that serves as an identification code is formed on the first side, and a light attenuation layer is disposed on the second side.

As a result, the radiation intensity of the lights that sequentially pass through the second side and the design on the first side and are incident on the reader can be prevented from increasing, and the contrast of signals of the reader can be improved. Accordingly, the readability of the design improves.

A medium according to the second embodiment of the present disclosure is described below with reference to the PET bottle 11b.

FIG. 5 is a sectional view of the PET bottle 11b that serves as a medium, according to the second embodiment of the present disclosure.

The PET bottle 11b is a cylindrical or tubular member including, for example, a mouth portion, a neck portion, a barrel portion, and a bottom portion. FIG. 5 illustrates a cross section of the PET bottle 11a cut by a horizontal plane parallel to the bottom.

As illustrated in FIG. 5, the PET bottle 11b includes a first side S1 and a second side S2. The first side S1 and the second side S2 are sides parallel to the axial direction of the PET bottle 11b that is a cylindrical or tubular member. The second side S2 is different from the first side S1 and do not overlap with each other. The first side S1 and the second side S2 may be sides of the neck portion or sides of the barrel portion. The PET bottle 11b in FIG. 5 has a cylindrical or tubular shape with a circular bottom. However, no limitation is indicated thereby, and the bottom of the PET bottle 11b may have other various kinds of shapes such'as a rectangular shape or a polygonal shape.

The bar code 111b according to the present embodiment serves as an identification code, and is a design included in the first side S1. A light reflecting layer is formed on the light color portion of the bar code 111b. The light reflecting layer is, for example, an aggregate of microstructures formed by irradiation with the pulsed laser beam 101L. The light attenuation layer 14 is arranged on the second side S2. It is desired that the light attenuation layer 14 be formed with an area equal to or greater than the area of the design formed on the first side S1. It is desired that the light attenuation layer 14 be formed so as to surround the design. By so doing, the light from the environment in which the PET bottle 11b is located can be controlled.

The light attenuation layer 14 according to the present embodiment has light attenuation properties. The light attenuation layer 14 is formed of, for example, a coloring material such as black ink. Alternatively, the light attenuation layer 14 may be formed by a region in which the second side S2 is irradiated with the pulsed laser beam 101L to alter the quality of the base material of the PET bottle that makes up the second side S2.

It is desired that the light attenuation layer 14 be formed on the second side S2 with an area equal to or greater than the area of the bar code 111b formed on the first side S1. Further, it is more preferable to form the light attenuation layer 14 so as to surround the bar code 111b in order to prevent ambient tight in which the PET bottle 11b is placed from being incident on the reader in addition to light emitted by the reader of the bar code 111b.

As described above, the PET bottle 11b includes the first side S1 and the second side S2 which is a side other than the first side S1, the bar code 111b that serves as an identification code is formed on the first side S1, and the light attenuation layer 14 is disposed on the second side S2.

Due to such a configuration, when the reader reads the bar code 111b, the light can be prevented from being incident on the reader through the second side S2. As a result, the contrast of signals on the bar code 111b improves, and the readability of the bar code 111b can be improved. As the processes of forming the light reflecting layer and the light attenuation layer are relatively simple, the cost of the medium can be reduced.

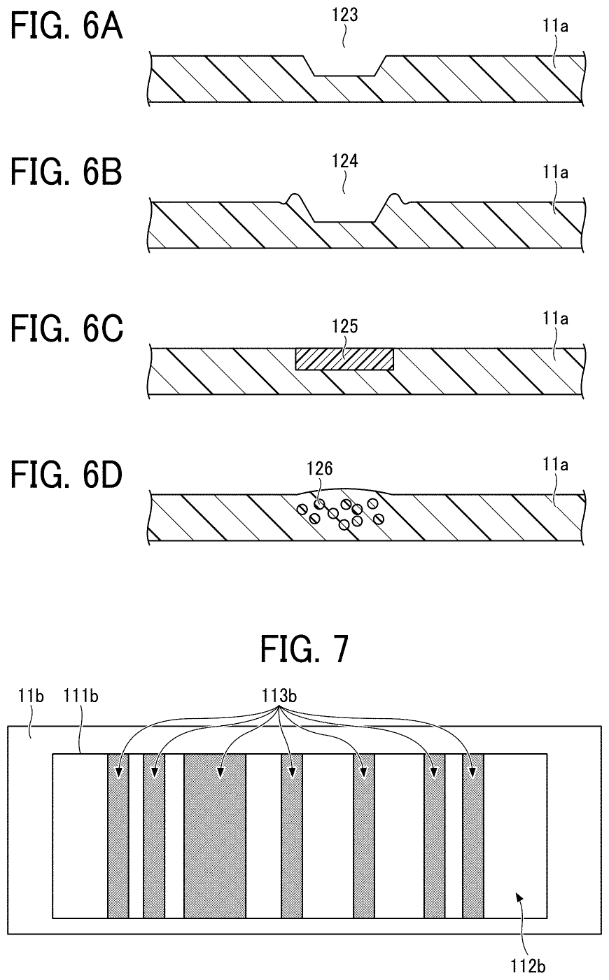

A method of forming the light reflecting layer 31 and the light attenuation layer 32 is described below. The forming method according to the present embodiment may be applied to the first or second embodiment of the present disclosure where appropriate. Firstly, a method of forming the light reflecting layer 31 is described below with reference to FIG. 6A, FIG. 6B, FIG. 6C, and FIG. 6D.

FIG. 6A, FIG. 6B, FIG. 6C, and FIG. 6D are sectional views of the light reflecting layer 31, which are used to illustrate microstructure of the light reflecting layer 31, according to the first embodiment of the present disclosure.

The light reflecting layer 31 is a layer that includes an aggregate of microstructures, and the aggregate of microstructures is formed as the medium 1 is irradiated with the laser beam. FIG. 6A illustrates a first case according to the present embodiment, and FIG. 6B illustrate a second case according to the present embodiment. FIG. 6C illustrate a third case according to the present embodiment, and FIG. 6D illustrates a fourth case according to the present embodiment. More specifically, FIG. 6A, FIG. 6B, FIG. 6C, and FIG. 6D schematically illustrate the sections of the material of the PET bottle 11a on which the light reflecting layer 31 is formed.

FIG. 6A illustrates a finely-evaporated uneven structure 123 that is formed as the base material of the PET bottle 11a is irradiated with a laser beam and evaporates. Such evaporation may be referred to as ablation in the following description. FIG. 6B illustrates a finely-melted uneven structure 124 that is formed as the base material a the PET bottle 11a is irradiated with a laser beam and is melted.

FIG. 6C illustrates a finely-crystalized structure 125 that is formed as the base material of the PET bottle 11a is irradiated with a laser beam and is crystalized. FIG. 6D illustrates a finely-foamed structure 126 that is formed as the base material of the PET bottle 11a is irradiated with a laser beam and foams. The microstructure according to the present embodiment may be implemented by combining the multiple structures in FIG. 6A to FIG. 6D.

A plurality of microstructures as illustrated in FIG. 6A to FIG. 6D are combined to form an aggregate. As a result, the light reflecting layer 31 is formed. However, the configuration of the light reflecting layer 31 is not limited to the configuration or structure illustrated in FIG. 6A, FIG. 6B, FIG. 6C, and FIG. 6D. The light reflecting layer 31 is satisfactory as long as it is an aggregate of microstructures having light reflexivity, which is formed by a change in the shape or physical properties of the base material that makes up a container such as the PET bottle 11a. Alternatively, other kinds of forming method such as cutting operation may be applied to a method of forming the light reflecting layer 31.

A method of forming the light attenuation layer 32 according to the present embodiment is described below. For example, the light attenuation layer 32 can be formed by altering the quality of the base material. Such an alteration of the quality of the base material is, for example, oxidation or carbonization. For example, the light attenuation layer 32 can be formed by irradiating the base material with a laser beam to alter the quality of the base material. The light attenuation layer 32 is formed by irradiation with a lower energy density on the irradiation face of the base material than the irradiation conditions of melting and ablation in the formation of the microstructures. By so doing, an oxidized or carbonized layer can be formed on the surface of the base material to from the light attenuation layer 32. The energy density may be lowered by, for example, shifting the focal point from the processed surface.

The base material is irradiated with a laser beam that is, for example, defocused and shifted from the focal point in the irradiation direction to apply heat energy to the base material. By so doing, an oxidized or carbonized layer can be formed on the surface of the base material to from the light attenuation layer 32. If the light attenuation layer that has a feature to attenuate the light due to a change in the shape or physical properties of the base material can be formed, methods other than a method of defocusing the laser beam for the irradiation can be applied. For example, the light attenuation layer 32 may be formed by a chemical change, chemical reaction, or a condensation.

Further, the light attenuation layer 32 may have a layer structure composed of a coloring material or the like arranged at the boundary between the surface of the medium and the outside of the medium so as to reduce the reflection and transmissive components of the light emitted to the medium. When the medium serves as a container, similar functionality may be applied to the to-be-contained object and then be stored.

The base material may contain a coloring material in either one of the light reflecting layer 31 or the light attenuation layer 32, or a layer that is made of a coloring material may be formed on the surface of the medium. For example, the layer structure may be formed on the surface of the base material by applying the ink of, for example, an oil-based pen. As only either one of the light reflecting layer 31 or the light attenuation layer 32 includes a coloring material, the usage of coloring material can significantly be reduced. Accordingly, the load of recycling can significantly be reduced. It is desired that the coloring material be applied to one of the light color portions and the dark color portions depending on the design, such that the sum total of the areas of the colored portions will be smaller than the sum total of the areas of the non-colored portions.

Modifications of Second Embodiment

First Modification of Second Embodiment

The structure or configuration of the bar code 111b according to the present modification of the second embodiment of the present disclosure is described below with reference to FIG. 7.

FIG. 7 is a diagram illustrating a bar code 111b according to a first modification of the second embodiment of the present disclosure.

As illustrated in FIG. 7, the bar code 111b according to the first modification of the second embodiment of the present disclosure has a plurality of light color portions 112b and a plurality of dark color portions 113b. In the present embodiment, when the bar code 111b is used as the design, the wavelength of the light that is emitted from the bar code reader for reading is, typically, the wavelength of red light around 650 nanometers (nm). Accordingly, if a red-light reflecting, layer is disposed on the 111b of the light color portion of the bar code 112b, the irradiated light is efficiently reflected and visually recognized. As a result, a high signal contrast between the light color portion and the dark color portion can be ensured. The light color portion 112b according to the present embodiment serves as the red reflecting layer.

If a layer that attenuates red light is disposed on the dark color portion 113b of the bar code 111b the emitted light does not pass through the dark color portion and is visually recognized as dark light. As a result, a high signal contrast between the light color portion and the dark color portion can be ensured. The dark color portion 113b according to the present embodiment serves as a red-light attenuation layer.

Moreover, a red-light attenuation layer may be disposed on the second side S2 to control the light that is incident on the reader after passing through the second side S2, instead of the dark color portion 113b or in addition to the dark color portion 113b. By so doing, the contrast of signals of the bar code 111b can be improved.

Second Modification of Second Embodiment

As the shape of the medium having a high affinity for design in the present invention, the medium may include a prism array structure 220 including a plurality of prism-like structures.

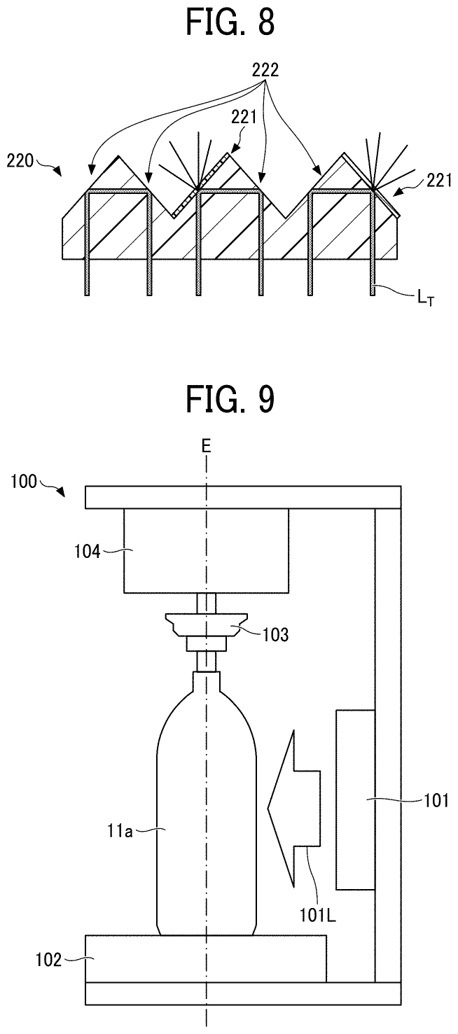

FIG. 8 is a diagram illustrating a configuration of such a prism array structure 220 according to the second embodiment of the present disclosure.

In FIG. 8, a cross section of the prism array structure 220 including three kinds of prism shapes is illustrated. The prism array structure 220 is disposed on at least some of the outer surface of the base material on the PET bottle 11b. The prism array structure 220 can be formed by, for example, thermally transferring the shape of a mold.

As illustrated in FIG. 8, the prism array structure 220 has a processed oblique portion 221 and a non-processed oblique portion 222. The processed oblique portion 221 is an oblique face on which an aggregate of microstructures is formed. The non-processed oblique portion 222 is an oblique face on which an aggregate of microstructures is not formed.

The transmitted light L_{T} that passes through the base material of the PET bottle 11b and is incident on the non-processed oblique portion 222 is reflected by the non-processed oblique portion 222. Accordingly, the transmitted light L_{T} is not emitted to the outside of the PET bottle 11b. Accordingly, when visually recognized from the outside of the PET bottle 11b, the region where the non-processed oblique portion 222 is disposed is visually recognized darkly.

By contrast, the transmitted light L_{T} that passes through the base material of the PET bottle 11b and is incident on the processed oblique portion 221 is reflected by the aggregate of microstructures on the processed oblique portion 221, and the reflected light is emitted to the outside of the PET bottle 11b. Accordingly, when visually recognized from the outside of the PET bottle 11b, the region where the processed oblique portion 221 is disposed is visually recognized brightly.

For example, when the first side PET bottle 11b S1 includes the prism array structure 220, the dark color portion of the bar code 111b is constituted by the non-processed oblique portion 222, and the light color portion is constituted by the processed inclined surface portion 221, a high contrast of signals of the bar code 111b can be ensured.

When the second side S2 of the PET bottle 11b includes the prism array structure 220, the light that is incident on the reader after passing through the second side S2 can be controlled. As a result, the contrast of signals of the bar code 111b can be improved.

When both the first side S1 and the second side S2 of the PET bottle 11b include the prism array structure 220, the provision of the prism array structure 220 on the first side S1 ensures high signal contrast of the bar code 111b, and the signal contrast of the bar code 111b can he improved by the provision of the prism array structure 220 on the second side S2.

As materials other than the material of the PET bottle 11b to he recycled are not adhered to or included in the PET bottle 11b, the recyclability can be improved.

FIG. 9 is a diagram illustrating a configuration or structure of the marking device 100 according to an embodiment of the present disclosure.

The marking device 100 according to the present embodiment may be applied to the first or second embodiment of the present disclosure where appropriate. As illustrated in FIG. 9, the marking device 100 is provided with a laser beam source 101, a conveyor 102, a holding mechanism 103, and a rotating mechanism 104.

The marking device 100 irradiates the PET bottle 11a with the pulsed laser beam 101L emitted from the laser beam source 101 while rotating, the PET bottle 11a held by the holding mechanism 103 around the rotation axis E by the rotating mechanism 104. As a result, an aggregate of microstructures can be formed on the surface of the base material or inside the base material of the PET bottle 11a.

The marking device 100 can convey the PET bottle 11a in a direction crossing the rotation axis E by the conveyor 102. The marking device 100 can form an aggregate of microstructures on a plurality of PET bottles 101L conveyed to the irradiation position of the pulsed laser beam 11a by the conveyor 102.

For example, a fiber laser can be applied to the laser beam source 101. The fiber laser is a laser beam source that makes use of an optical fiber doped with a rare-earth element as a laser medium. The laser beam source 101 emits the pulsed laser beam 101L with a short input impulse such as of picoseconds or nanoseconds.

However, the laser beam source 101 is not limited to a fiber laser, and various kinds of laser beam sources may he used. The laser beam that is emitted from the laser beam sources 101 may be pulsed light or continuous wave (CW). However, from the viewpoint of, for example, peak energy, a laser beam that can oscillate a pulse in picosecond to nanosecond is preferable.

The solid-state laser may be, for example, a yttrium aluminum garnet (YAG) laser and a titanium sapphire laser. The gas laser may be, for example, an argon laser, a helium-neon laser, and a carbon dioxide laser. Preferably, the size of a semiconductor laser is small. The fiber laser is a more preferable light source than the other kinds of laser beam sources in view of its high peak energy and a high potential of miniaturization.

The laser beam source 101 may include an optical scanner that scans the PET bottle 11a with the pulsed laser beam 101L emitted from a fiber laser. In such cases, the scanned pulsed laser beam 101L is emitted to the PET bottle 11a to form an aggregate of microstructures.

The conveyor 102 conveys the PET bottle 11a placed on the belt by causing the belt to travel by driving force of rotation of a roller [[for example]] that supports the belt. However, other than the belt conveyor, a conveyance unit that adopts a roller or the like may be used.

The holding mechanism 103 holds the PET bottle 11a in contact with the inner surface or the outer surface of the mouth of the PET bottle 11a. However, the to-be-held portion is not limited to the mouth of the PET bottle, and other portions such as a body, a barrel, or a bottom may be held.

The holding mechanism 103 can switch between a state of contact with the PET bottle 11a and a state of non-contact with the PET bottle 11a to switch whether the PET bottle 11a is to be held or not to be held. The holding mechanism 103 can also lift the PET bottle 11a in a direction parallel to the rotation axis E when the PET bottle 11a is being held.

The rotating mechanism 104 according to the present embodiment is a rotatable stage that rotates the PET bottle 11a held and lifted by the holding mechanism 103 around the rotation axis E. The rotating mechanism 104 is controlled by, for example, a controller, and can start or stop the rotation. Moreover, the rotating mechanism 104 can control, for example, continuous rotation, stepwise rotation, or equal-speed rotation.

However, the configuration or structure of the marking device 100 is not limited to the configuration or structure described as above with reference to FIG. 9. An aggregate of microstructures may be formed by changing the irradiation position of the pulsed laser beam 101L. In such a method, the PET bottle 11a is not driven and held still.

When the PET bottle 11ais driven, the PET bottle 11a is rotated by a predetermined angle, and then the PET bottle 11a is made stopped moving. Subsequently, the stopped PET bottle 11a is irradiated with the pulsed laser beam 101L to form an aggregate of microstructures, and then the PET bottle is rotated again by a predetermined angle. The above operation may be repeated to form an aggregate of microstructures on the PET bottle 11a.

In the configuration or structure according to present embodiment described with reference to FIG. 9, the rotation axis E is parallel to the direction of gravity. However, no limitation is indicated thereby, and the rotation axis E may be configured to intersect with the direction of gravity.

In a configuration or structure in which the marking device 100 is not provided with the rotating mechanism 104, the PET bottle 11a may be disposed such that the longer-side direction or the cylindrical axis direction thereof is parallel to the direction of gravity, or the PET bottle 11a may be disposed such that, the longer-side direction or the cylindrical-axis direction thereof intersects the direction of gravity.

For example, the marking device 100 according to the present embodiment may include a plurality of laser beam sources 101, and may be configured to irradiate the PET bottle 11a with the multiple pulsed laser beams 101L in parallel from a plurality of directions around the rotation axis E.

In the configuration or structure according to present embodiment described with reference to FIG. 9, the rotation axis E is parallel to the direction of gravity. However, no limitation is indicated thereby, and the rotation axis E may be configured to intersect with the direction of gravity. In a configuration or structure in which the marking device 100 is not provided with the rotating mechanism 104, the PET bottle 11a may be disposed such that the longer-side direction or the cylindrical-axis direction thereof is parallel to the direction of gravity, or the PET bottle 11a may be disposed such that the longer-side direction or the cylindrical-axis direction thereof intersects the direction of gravity. Further, for example, the marking device 100 according to the present embodiment may include a plurality of laser beam sources 101, and may be configured to irradiate the PET bottle 11a with the multiple pulsed laser beams 101L in parallel from a plurality of directions around the rotation axis E.

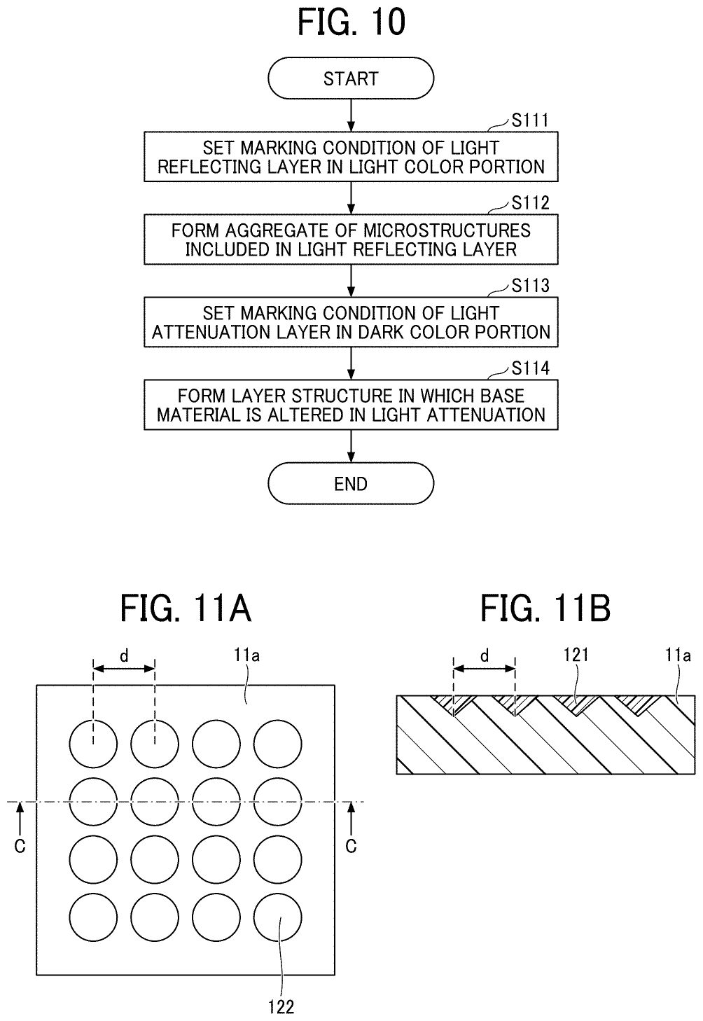

The operation of the marking device 100 is described below with reference to FIG. 10.

FIG. 10 is a flowchart of the processes performed by the marking device 100, according to an embodiment of the present disclosure.

More specifically, FIG. 10 illustrates the processes triggered by a timing at which the marking device 100 is activated or turned on, according to the present embodiment.

Firstly, in a step S111, the marking device 100 sets the marking condition of the light reflecting layer 31 in the light color portion 112a.

In the present embodiment, the term marking refers to forming a pattern to be included in the light reflecting layer 31 or the light attenuation layer 32. Such a pattern may include an aggregate of microstructures, or may include a coloring material such as ink. The marking condition refers to a condition under which marking is performed.

For example, conditions such as light-emission frequency, pulse widths, and focal points of the pulsed laser beam 101L, a scanning speed when the pulsed laser beam 101L is scanned, and a resolution of the aggregate of the microstructures are set so that the aggregate of the microstructures of the light reflecting layer 31 can be formed at a predetermined position on the base material of the PET bottle 11a.

Subsequently, in a step S112, the marking device 100 forms an aggregate of microstructures inducted in the light reflecting layer 31 in the light color portion 111a of the bar code 112a according, to the set marking condition.

Subsequently, in a step S113, the marking device 100 sets a marking condition of the light attenuation layer 32 in the dark color portion 113a. For example, conditions such as light-emission frequency, pulse widths, and focal points of the pulsed laser beam 101L, a scanning speed when the pulsed laser beam 101L is scanned, and a resolution in an aggregate of microstructures are set so that a layer structure in which the base material of the light attenuation layer 32 is altered can be formed at a predetermined position in the base material of the PET bottle 11a.

Subsequently, in a step S114, the marking device 100 forms a layer structure in which the base material is altered on the light attenuation layer 32 in the dark color portion 113a of the bar code 111a according to the marking condition set in the step S113.

In this manner, the marking device 100 can form the bar code 111a. The order in which a step of forming the aggregate of microstructures in the light reflecting layer 31 in the step S111 and the step S112 and a step of forming a layer structure in which the base material is altered on the light attenuation layer 32 in the step S113 and the step S114 are performed may be switched. In other words, the step of forming a layer structure in which the base material is altered on the light attenuation layer 32 may be performed first, and the step of forming the aggregate of microstructures in the light reflecting layer 31 may be performed afterward.

A result of forming an aggregate of microstructures by the marking device 100 is described below.

FIG. 11A and FIG. 11B are diagrams each illustrating a configuration of an aggregate of the microstructures in the light reflecting layer 31, according to the first embodiment of the present disclosure.

FIG. 11A is a front view of an aggregate of the microstructures in the light reflecting layer 31, according to the first embodiment of the present disclosure. FIG. 11B is a sectional view of an aggregate of the microstructures in the light reflecting layer 31, which is taken along a cut line C-C of FIG. 11A, according to the first embodiment of the present disclosure.

In FIG. 11A and FIG. 11B, a plurality of recesses 122 are illustrated that are formed on the base material of the PET bottle 11a as an aggregate of microstructures. The multiple recesses 122 may collectively he referred to as a plurality of recesses. Each one of the multiple recesses 122 is conical in shape, where the intervals d therebetween is 128 micrometers (μm), the resolution is 200 dots per inch (dpi), and the depth is approximately 10 μm. However, no limitation is intended thereby, and each of the shape, the intervals, and the depth of the microstructure can be appropriately selected as long as the light can be reflected. For example, convex portions, crystallized structures, or foamed structures may also be formed.

It is desired that the marking condition be set so that the light can be reflected and the surface roughness of the base material will be rougher than that of the light attenuation layer 32 on the dark color portion 103a. This is because the diffuse reflection on the surface of the base material is more enhanced as the degree of surface roughness on the base material is greater. By making the degree of surface roughness on the base material greater, the contrast of signals between the light color portion 102a and the dark color portion 103a can further be enhanced.

Further, it is desired that the marking condition be set such that the difference in reflectivity with the light attenuation layer 32 formed on the dark color portion 103a is equal to or greater than 30%. By setting the difference in reflectivity between the light color portion 102a and the dark color portion 103a to be equal to or greater than 30%, the bar code 111a can be read stably and accurately even when a reader for the bar code 111a or an environment for reading changes.

For example, an oxidized or carbonized layer can be used as the light attenuation layer 32. An oxidized or carbonized layer can be formed by making the focal point of the pulsed laser beam 101L different from the marking condition for forming the multiple recesses 122 in the light reflecting layer 31. The focal point of the pulsed laser beam 101L according to the present embodiment serves as a marking condition and a conditions formation. However, as long as a layer having light attenuation properties can be formed on the base material, marking condition or forming conditions other than the light focal point may be modified.

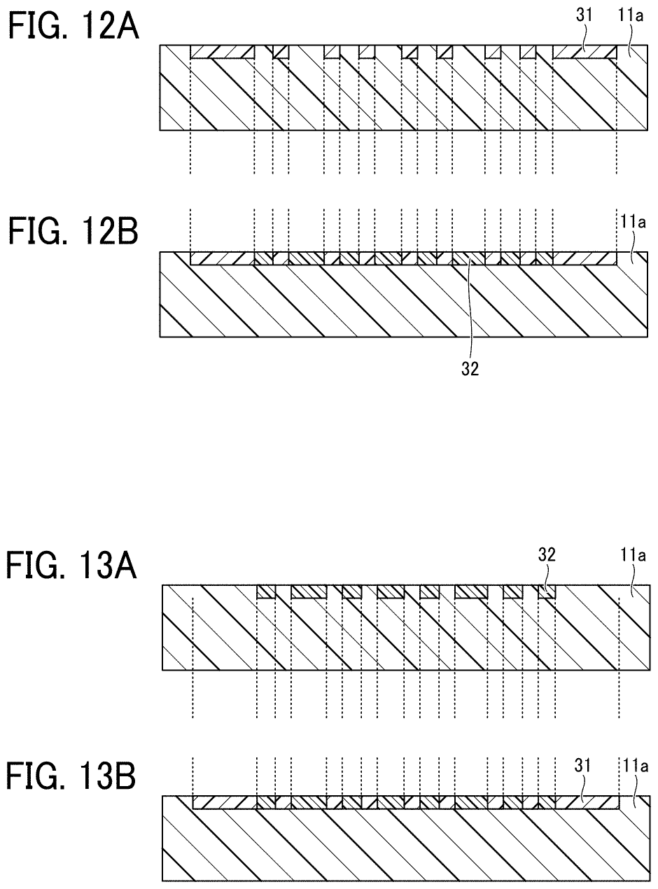

FIG. 12A and FIG. 12B are diagrams each illustrating the flow of the procedure for forming the bar code 111a on the PET bottle 11a, according to a first case of the first embodiment of the present disclosure.

FIG. 12A is a sectional view of the light reflecting layer 31, illustrating how the light reflecting layer 31 is formed, according to the first case of the above embodiments of the present disclosure. FIG. 12B is a sectional view of the light attenuation layer 32, illustrating how the light attenuation layer 32 is formed, according to the first case of the above embodiments of the present disclosure.

As illustrated in FIG. 12A, firstly, the marking device 100 according to the first case of the above embodiments of the present disclosure forms the light reflecting layer 31 on the base material of the PET bottle 11a. Subsequently, as illustrated in FIG. 12B, the marking device 100 according to the first case of the above embodiments of the present disclosure forms the light attenuation layer 32 on the base material of the PET bottle 11a.

FIG. 13A and FIG. 13B are diagrams each illustrating the flow of the procedure for forming the bar code 111a on the PET bottle 11a, according to a second case of the above embodiments of the present disclosure.

FIG. 13A is a sectional view of the light attenuation layer 32, illustrating how the light attenuation layer 32 is formed, according to the second case of the above embodiments of the present disclosure. FIG. 13B is a sectional view of the light reflecting layer 31, illustrating how the light reflecting layer 31 is formed, according to the second case of the above embodiments of the present disclosure.

As illustrated in FIG. 13A, firstly, the marking device 100 according to the second case of the above embodiments of the present disclosure forms the light attenuation layer 32 on the base material of the PET bottle 11a. Subsequently, as illustrated in FIG. 13B, the marking device 100 according to the second case of the above embodiments of the present disclosure forms the light reflecting layer 31 on the base material of the PET bottle 11a.

The aggregate of microstructures in the light reflecting layer 31 and the layer structure in which the base material in the light attenuation layer 32 has been altered is not necessarily formed in two separate steps. For example, the formation may be performed at one time while switching between a marking condition corresponding to the light reflecting layer 31 in the region of the light reflecting layer 31 and a marking condition corresponding to the light attenuation layer 32 in the region of the light attenuation layer 32 according to the region.

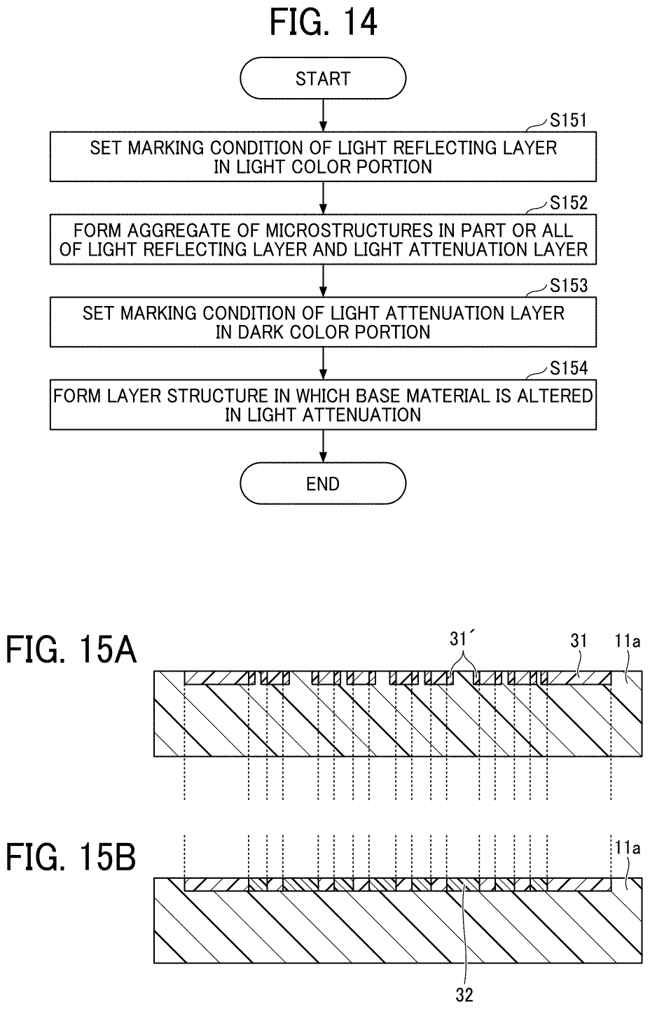

FIG. 14 is a flowchart of the processes performed by the marking device 100, according to an alternative embodiment of the present disclosure.

More specifically, in a similar manner to FIG. 10, FIG. 14 illustrates the processes triggered by a timing at which the marking device 100 is activated or turned on, according to the present embodiment.

The processes of a step S151 in FIG. 14 are equivalent to the processes of the step S111 in FIG. 10. Thus, the overlapping description of the processes of the step S151 in FIG. 14 are omitted. The processes or a step S153 and a step S154 in FIG. 14 are equivalent to the processes of the step S113 and the step S114 in FIG. 10, respectively. Thus, the overlapping description of the processes of the step S153 and the step S154 in FIG. 14 are omitted.

In a step S152, the marking device 100 forms an aggregate of microstructures in a part or all of the light reflecting layer 31 and the light attenuation layer 32 according to the marking condition for forming the aggregate of microstructures in the light reflecting layer 31.

FIG. 15A and FIG. 15B are diagrams each illustrating the flow of the procedure for forming the bar code 111a on the PET bottle 11a, according to a third case of the present embodiment.

FIG. 15A is a sectional view of the light reflecting layer 31 and the light attenuation layer 32, illustrating how an overlapping area of the light reflecting layer 31 and the light attenuation layer 32 is formed, according to the third case of the above embodiments of the present disclosure. FIG. 15B is a sectional view of the light attenuation layer 32, illustrating how the light attenuation layer 32 is formed, according to the third case of the above embodiments of the present disclosure.

As illustrated in FIG. 15A, in addition to the light reflecting layer 31, the marking device 100 forms the light reflecting layer 31 made of an aggregate of microstructures in an overlapping area 31′ where the light reflecting layer 31 and the light attenuation layer 32 overlap each other in the light attenuation layer 32. The overlapping area 31′ corresponds to the obliquely-hatched area in FIG. 15A.

Subsequently, as illustrated in FIG. 15B, the marking device 100 according to the third case of the above embodiments of the present disclosure forms the light attenuation layer 32 in the overlapping area 31′ and the area corresponding to the light attenuation layer 32.

When the light attenuation layer 32 is formed after the light reflecting layer 31 is formed, there may be some cases in which a region in which an aggregate of microstructures is not formed is generated between the light reflecting layer 31 and the light attenuation layer 32 due to the displacement of the formation position and the readability of the bar code 111a may deteriorate. In order to handle such a situation, the overlapping area 31′ may be arranged in which the light reflecting layer 31 and the light attenuation layer 32 overlap each other. By so doing, the occurrence of a region in which an aggregate of microstructures is not formed can be prevented, and a decrease in readability can be prevented.

### Third Embodiment

A marking device 100c according to a third embodiment of the present disclosure is described below.

The hardware configuration of the marking device 100c according to the third embodiment of the present disclosure is equivalent to the configuration of the marking device 100 illustrated in FIG. 15A and FIG. 15B to which an optical scanner 101a to scan the pulsed laser beam 101L on the base material of the PET bottle 11c is added. The PET bottle 11c according to the present embodiment serves as a container.

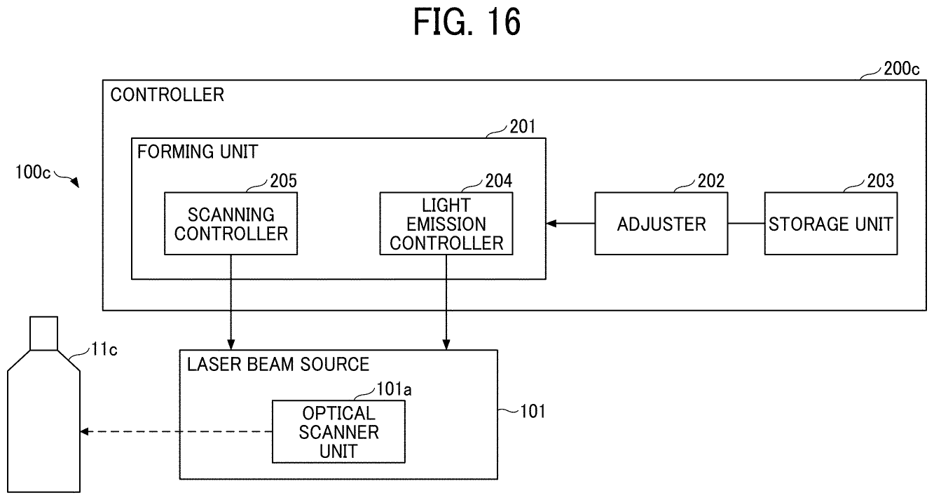

FIG. 16 is a block diagram of a functional configuration of a controller 200c included in the marking device 100c, according to the third embodiment of the present disclosure.

In FIG. 16, a PET bottle 11c and the laser beam source 101 are also included in addition to the marking device 100c. The controller 200c includes a forming unit 201, an adjuster 202, and a storage unit 203. The solid-line arrows in FIG. 16 indicate electrical signals, and the arrows with broken lines indicate the pulsed laser beam 101L.

Such functions of the forming unit 201 and the adjuster 202 may be implemented by an electric circuit, or some of or all of those functions may be implemented by software or a central processing unit (CPU). Alternatively, these functions may be implemented by a plurality of electric circuits or a plurality of software components. For example, the functionality of the storage unit 203 is implemented by a storage device such as a hard disk drive (HDD) or a solid state drive (SSD).

The forming unit 201 includes a light emission controller 204 and a scanning controller 205, and has the function of making the pulsed laser beam 101L emitted from the laser beam source 101 perform marking on the PET bottle 11c that has transparency and is colorless or colored.

The light emission controller 204 controls light emission of the laser beam source 101. An object to be controlled by the light emission controller 204 is, for example, the start or stop of the light emission by the laser beam source 101, the frequencies of light emission, or the pulse widths or light intensities of the pulsed laser beam 101L.

The scanning controller 205 controls the optical scanning of the pulsed laser beam 101L on the base material of the PET bottle 11c, which is performed by the optical scanner unit 101a included in the laser beam source 101. An object to be controlled by the unit 205 is, for example, the start or stop of optical scanning by the optical scanner unit 101a, or the scanning speed.

For example, the optical scanner unit 101a is configured by a polygon mirror, a galvano mirror, or a micro electro mechanical system (MEMS). In the present embodiment, a configuration in which the laser beam source 101 includes an optical scanner 101a is described. However, the marking device 100c may include the optical scanner iota in a separate manner from the laser beam source 101.

It is also possible for the marking device 100c to implement a function similar to the function of controlling the multiple light emitter of the laser beam source to perform scanning on the base material of the PET bottle 11c using the pulsed laser beam 101L, without the optical scanner 101a.

The storage unit 203 stores the information about, the to-be-contained object. The information about the to-be-contained object includes, for example, the information about the type of beverage such as coffee, tea, carbonated drinks, or mineral water, and the information about the color, the reflectivity, transmissivity, or light diffusivity of the beverage.

The adjuster 202 refers to the storage unit 203 to obtain the information about the to-be-contained object, and adjusts the marking condition by the forming unit 201 according to the information about the to-be-contained object stored in the PET bottle 11c.

The forming unit 201 can perform marking by controlling the laser beam source 101 and the optical scanner unit 101a using the light emission controller 204 and the scanning controller 205 based on the marking condition adjusted by the adjuster 202.

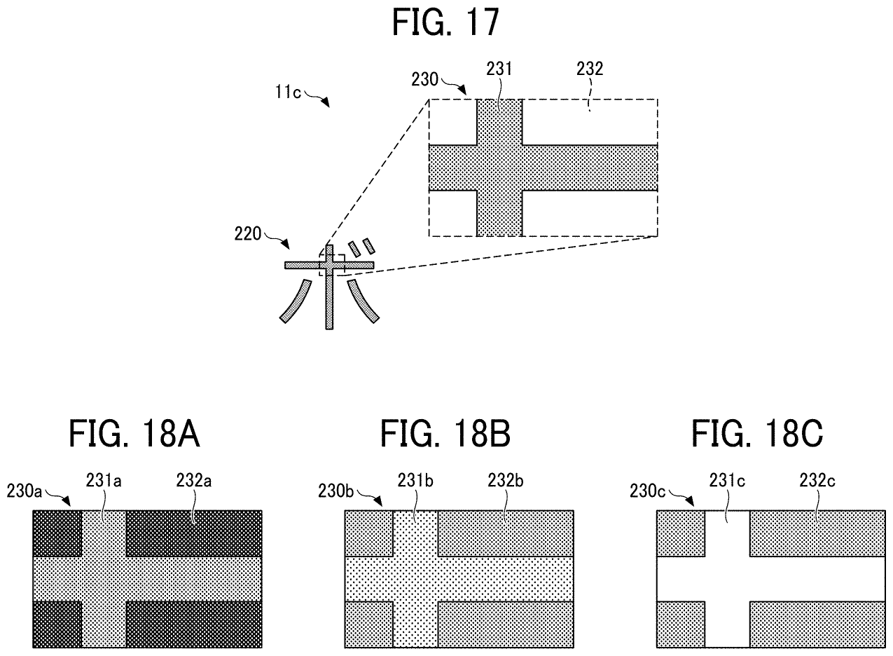

FIG. 17 is a diagram illustrating a configuration or structure of an image formed by the marking device 100c, according to the third embodiment of the present disclosure.

More specifically, FIG. 17 is a diagram illustrating the allocation of a marking area 231 and a plurality of non-marking areas 232 according to the third embodiment of the present disclosure. The contrast. between the marking area 231 and the multiple non-marking areas 232 as illustrated in FIG. 17 does not indicate the contrast caused by the marking.

As illustrated in FIG. 17, a magnified image 230 is an image obtained by enlarging a part of the image 225. The magnified image 230 includes the marking areas 231 marked on the base material of the PET bottle 11c and the multiple non-marking areas 232 that are not to be marked.

The marking device 100c performs marking on the marking area 231 upon allocating the marking area 231 and the multiple non-marking areas 232 based on the input image data. As a result, an image 225 is formed on the PET bottle 11c.

A method of allocating the marking area 231 and the multiple non-marking areas 232 is not limited to any particular method. For example, the allocation can be performed using the coordinate data of a pixel array.

FIG. 18A, FIG. 18B, and FIG. 18C are diagrams each illustrating a configuration or structure of an image formed by the marking device 100c, according to alternative cases of the third embodiment of the present disclosure.

FIG. 18A is a diagram illustrating a configuration or structure of an image formed by the marking device 100c, according to a first case of the third embodiment of the present disclosure. FIG. 18B is a diagram illustrating a configuration or structure of an image formed by the marking device 100c, according to a second case of the third embodiment of the present disclosure. FIG. 18C is a diagram illustrating a configuration or structure of an image formed by the marking device 100c, according to a third case of the third embodiment of the present disclosure.

FIG. 18A illustrates a magnified image 230a that is visually recognized when an to-be-contained object such as a black beverage is contained inside the PET bottle 11c. In the multiple non-marking areas 232a, a black to-be-contained object inside the PET bottle 11c is visually recognized darkly. The marking area 231a has high light diffusivity of the diffuse reflection light due to an aggregate of the microstructures. Accordingly, the marking area 231a becomes bright and visible with high contrast compared with the non-marking area 232a.

FIG. 18B illustrates a magnified image 230b that is visually recognized when an to-be-contained object such as a white beverage is contained inside the PET bottle 11c. In the multiple non-marking areas 232b, a white to-be-contained object inside the PET bottle 11c is visually recognized brightly. As the multiple non-marking areas 232b is bright and the marking area 231b is also visually recognized as being bright due to diffuse reflection light in the aggregate of microstructures, the marking area 231b according to the present embodiment is visually recognized with low contrast compared with the configuration illustrated in FIG. 18A.

In a similar manner to FIG. 18B, FIG. 18C illustrates a magnified image 230c that is visually recognized when an to-be-contained object such as a white beverage is contained inside the PET bottle 11c. However, in the magnified image 230c, the brightness of the marking area 231c is adjusted so as to be further brightened according to the color of the to-be-contained object. As a result, the contrast of the magnified image 230c is improved as compared with the configuration illustrated in FIG. 18B. Such brightness adjustment can be performed by adjusting the shape or physical properties of the aggregate of microstructures to be formed.

In the above embodiment described with reference to FIG. 18C, the brightness of the marking area 231c is adjusted so as to be further brightened according to the color of the to-be-contained object. However the brightness of the marking area 231c may be adjusted so as to be darkened according to the color of the to-be-contained object.

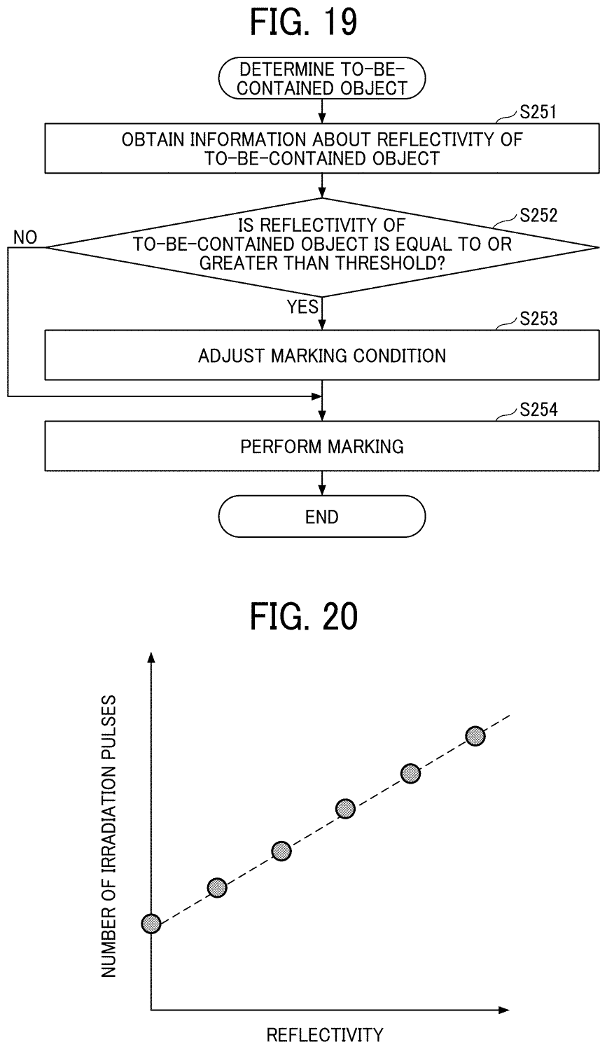

The operation of the marking device 100c is described below with reference to FIG. 19.

FIG. 19 is a flowchart of the processes performed by the marking device 100c, according to the third embodiment of the present disclosure.

More specifically, FIG. 19 illustrates the operation of the marking device 100c, when the marking device 100c is turned on, to be performed after the to-be-contained object is determined and the information about the determined to-be-contained object stored in the PET bottle 11c on which an image is to he formed is input to the marking device 100c. The operation of the marking device 100c according to the present embodiment when the reflectivity of the to-be-contained object is equivalent to the information about the to-be-contained object is described below.

For example, in an initial state, the marking device 100c determines the marking condition when the reflectivity of the to-be-contained object is not equal to or greater than a predetermined threshold. In such a configuration, when the reflectivity of the to-be-contained object is equal to or greater than a predetermined threshold, the contrast between the marking area 231 and the non-marking area 232 decreases, and the visibility of the image decreases. Accordingly, the marking device 100c adjusts the marking condition, and performs marking based on the adjusted marking condition.

Firstly, in a step S251, the adjuster 202 refers to the storage unit 203 in view of the information about the to-be-contained object, and obtains the information about the reflectivity of the to-be-contained object.

Subsequently, in a step S252, the adjuster 202 determines whether or not the reflectivity of the to-be-contained object is equal to or greater than a predetermined threshold.

When it is determined in the step S252 that the reflectivity of the to-be-contained object is not equal to or greater than a predetermined threshold (“NO” in the step S252), the operation shifts to a step S254. By contrast, when it is determined in the step S252 that the reflectivity of the to-be-contained object is equal to or greater than a predetermined threshold (“YES” in the step S252), the operation shifts to the step S253.

Subsequently, in a step S253, the adjuster 202 adjusts the marking condition. For example, when the reflectance is equal to or greater than a threshold value, the marking condition is adjusted to a predetermined condition that can ensure contrast.

Subsequently, in a step S254, the forming unit 201 performs marking on the base material of the PET bottle 11c.

As described above, the marking device 100c can perform marking on the base material of the PET bottle 11c to form an image thereon.

In the present embodiment, the reflectivity of the to-be-contained object is referred to as the information about the to-be-contained object. However, no limitation is intended thereby. For example, the marking condition may be adjusted according to information about the spectral characteristics of the to-be-contained object or information such as transparency.

In the present embodiment, a configuration is referred to in which the marking condition is adjusted according to the result of determination as to whether or not the reflectivity is equal to or greater than the threshold. However, no limitation is intended thereby. For example, the marking condition can be adjusted according to a predetermined look up table (LUT).

FIG. 20 is a diagram illustrating a look up table (LUT) according to an embodiment of the present disclosure.

The horizontal axis in FIG. 20 denotes the reflectivity, and the vertical axis in FIG. 20 denotes the number of irradiation pulses of the pulsed laser beam 101L. By adjusting the number of irradiation pulses to be larger as the reflectivity is higher, the light diffusivity in the marking area 231 on the PET bottle 11c is further increased, and the contrast to the multiple non-marking areas 232 in which the to-be-contained object having high reflectivity are visually recognized can be secured.

As the reflectance, a reflectance for a. specific wavelength may be used, or an average reflectance in a predetermined wavelength band may be used. In the present embodiment, the number of irradiation pulses is referred to as the marking condition that is indicated by the vertical axis in FIG. 20. However, no limitation is intended thereby. Other various types of conditions may be adjusted as long as the conditions can change the properties and characteristics of the marking.

For example, the amount of energy per space or time in the pulsed laser beam 101L can be adjusted. In the case of energy per space, the changes in marking condition may be, for example, a reduction in size of a spot on which the pulsed laser beam 101L is focused and an increase in interval or density of pixels among positions irradiated with the pulsed laser beam 101L. In the case of energy per unit time, the changes in marking condition may be, for example, an increase in the amount of energy of the pulsed laser beam 101L.

Further, the marking condition at the marking position may change depending on the amount of filling material such as the amount of to-be-contained object stored in the PET bottle 11c.

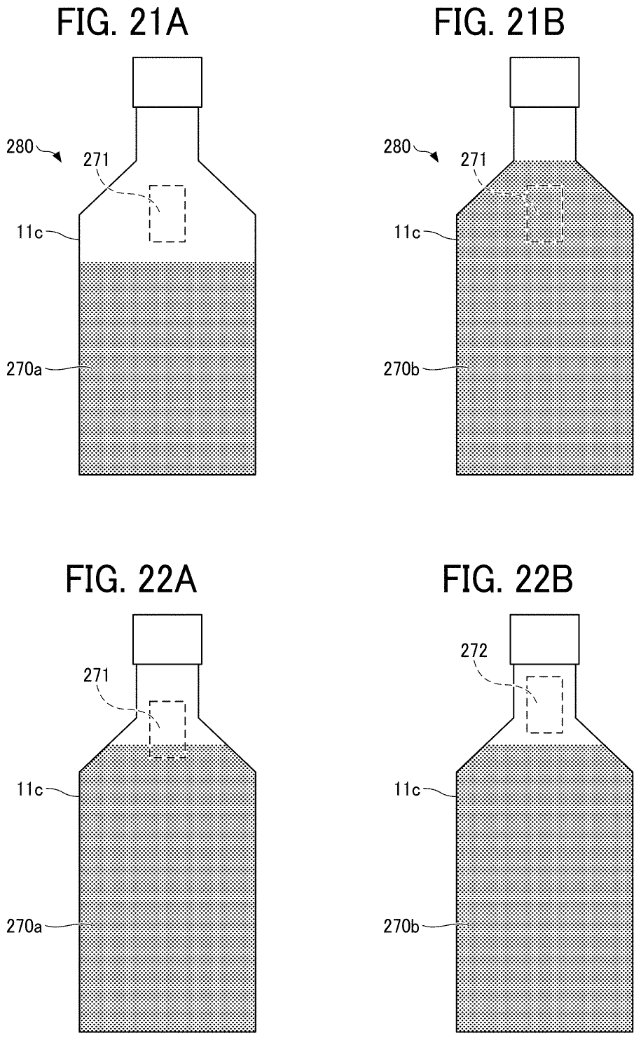

FIG. 21A and FIG. 21B are diagrams each illustrating the amount of filling material such as the amount of to-be-contained object, according to the third embodiment of the present disclosure.

FIG. 21A is a diagram illustrating the amount of tilling material such as the amount of to-be-contained object 270a, according to a first case of the third embodiment of the present disclosure. FIG. 21B is a diagram illustrating the amount of filling material such as the amount of to-be-contained object, according to a second case of the third embodiment of the present disclosure.

In the present embodiment, the PET bottle 11c and the to-be-contained objects (270a and 270b) accommodated in the PET bottle 11c constitute the accommodating body 280.

In FIG. 21A, the amount of filling material such as the amount of the to-be-contained object 270a stored in the PET bottle 11c is small, and the marking position 271 is not covered by the to-be-contained object 270a. By contrast, in FIG. 21B, the amount of filling material such as the amount of the to-be-contained object 270b stored in the PET bottle 11c is large, and the marking position 271 is covered by the to-be-contained object 270b. Accordingly, even in the same type of to-be-contained object, the amount of filling material such as the amount of to-be-contained object can be used as the information about the to-be-contained object, and the marking condition can be adjusted according to the amount of filling material such as the amount of filling materials.

Depending on the amount of filling material such as the amount of to-be-contained object, a boundary area between the to-be-contained object and air in the PET bottle 11c may be included in the marking position.

FIG. 22A and FIG. 22B are diagrams each illustrating the amount of filling material such as the amount of to-be-contained object, according to the third embodiment of the present disclosure.

FIG. 22A is a diagram illustrating the amount of filling material such as the amount of to-be-contained object, according to a third case of the third embodiment of the present disclosure. FIG. 22B is a diagram illustrating the amount of filling material such as the amount of to-be-contained object, according to a fourth case of the third embodiment of the present disclosure.

In FIG. 22A, a boundary area between the to-be-contained object and the air in the PET bottle 11c is included in a marking area 271. When a bar code or the like is formed as an image, there are some cases in which the bar code cannot accurately be read because the boundary area cannot be distinguished from the bar code.

In order to deal with such a situation, the marking position may be included in the marking condition. In particular, when a boundary area between the to-be-contained object and air in the PET bottle 11c is included in the marking position, the marking position can also be adjusted.

FIG. 22B illustrates a state in which the marking position 272 is adjusted such that the boundary area between the to-be-contained object and the air in the PET bottle 11c will not be included in the marking position. Accordingly, for example, an error in the reading of the bar code due to the boundary area being included in the marking position can be controlled.

When the marking position is to be adjusted, from the viewpoint of securing the reflectivity, the adjustment to an area of air in which the to-be-contained object is not stored is more preferable than the adjustment to an area of the PET bottle 11c in which the to-be-contained object is stored.

When the marking position is to be adjusted, it is desired that the height of the to-be-contained object in the PET bottle 11c be determined based on the amount of filling material such as the amount of to-be-contained object and the capacity of the PET bottle 11c. In order to achieve such functions, the adjuster 202 may be configured to compute and obtain the height of the to-be-contained object in the PET bottle 11c based on the amount of filling material such as the amount of to-be-contained object and the capacity of the PET bottle 11c.

Further, in the case of transparent to-be-contained object with transparency such as water, environmental conditions such as illumination also affect the reading performance of the bar code in addition to the information about the to-be-contained object. In order to handle such a situation, the adjuster 202 may be provided with a function of computing the brightness in the multiple non-marking area 232 based on the condition of illumination.

The bar code according to the present embodiment serves as an image to be formed on the PET bottle 11c.

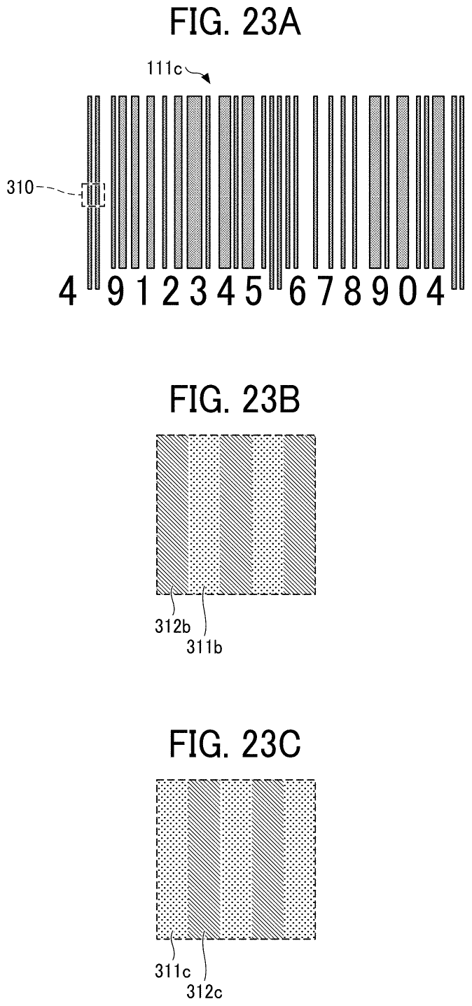

FIG. 23A, FIG. 23B, and FIG. 23C are diagrams each illustrating a bar code 111c according to an embodiment of the present disclosure.

FIG. 23A is a diagram illustrating a schematic configuration of a bar code 111c according to an embodiment of the present disclosure. FIG. 23B is a diagram illustrating a magnified image of an area 310 in FIG. 23A, according to a first case of the present embodiment. FIG. 23C is a diagram illustrating a magnified image of the area 310 in FIG. 23A, according to a second case of the present embodiment.

The bar code 111c includes a light color portion and a dark color portion. For example, when the reflectivity of the to-be-contained object stored in the PET bottle 11c is low, as illustrated in FIG. 23B, it is desired that the light color portion 311b be set as the marking area. By contrast, when the reflectivity of the to-be-contained object is high, as illustrated in FIG. 23C, it is desired that the dark color portion 312 be set as the marking area. As described above, it is desired that the light color portion and the dark color portion of the bar code 111c be reversed according to the information about the to-be-contained object such as the reflectivity.

In the present embodiment, some images that are formed on the PET bottle 11c are necessary only after the to-be-contained object is consumed. For example, there is no problem even if a recycle mark of the PET bottle has a low readability before the to-be-contained object is consumed.

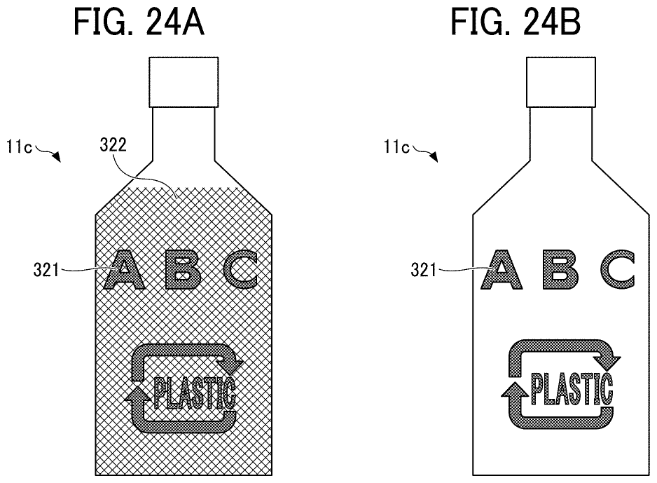

FIG. 24A and FIG. 24B are diagrams each illustrating a PET bottle 11c before and after the to-be-contained object is consumed, according to an embodiment of the present disclosure.

FIG. 24A is a diagram illustrating the PET bottle 11c before the to-be-contained object is consumed, according to the present embodiment of the present disclosure. FIG. 24B is a diagram illustrating the PET bottle 11c alter the to-be-contained object is consumed, according to the present embodiment of the present disclosure.

As illustrated in FIG. 24A, when the to-be-contained object is filled and the storage object 322 is not yet consumed, the contrast of the image 321 is low, and it is difficult to visually recognize the characters and figures included in the image.

By contrast, as illustrated in FIG. 24B, when the to-be-contained object is not filled and the storage object 322 has already been consumed, the contrast of the image 321 is high, and it is easy to visually recognize the characters and figures included in the image.

Accordingly, it is preferable not to adjust the marking condition when low readability of an image does not matter before the to-be-contained object is consumed. As described above, whether-or not to adjust the marking condition may be determined according to the type of an image. By not adjusting the marking condition, the productivity of image formation on the PET bottle 11c can be increased.

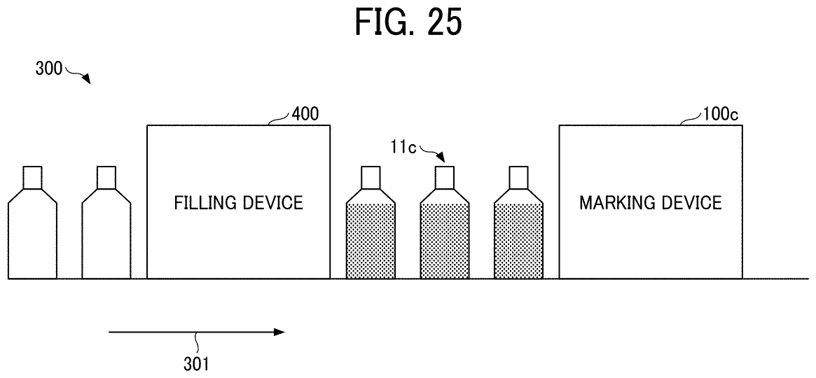

FIG. 25 is a diagram illustrating a configuration of a manufacturing line 300 according to an embodiment of the present disclosure.

As illustrated in FIG. 25, the manufacturing line 300 includes a marking device 100c and a filling device 400.

In the manufacturing line 300, the PET bottle 11c that is conveyed in a conveyance direction 301 is filled with to-be-contained object by the filling device 400, and then an image is formed by the marking device 100c. The marking device 100c and the filling device 400 share the information about the to-be-contained object to be stored in the PET bottle 11c. As a result, the configuration of the manufacturing line 300 can be simplified, and the information can be efficiently utilized. The sharing method may be any method including, for example, a method through wireless connection or wired connection.

Some advantageous effects of the marking device 100c are described below.

In a transparent medium such as a PET bottle for beverage, there may be some cases in which the visibility of an image formed on the medium is unstable. In particular, an identification code such as a bar code is required to be accurately read regardless of the surrounding environment, and thus a demand for reading stability is further high.

In order to handle such a situation, some techniques have been proposed that provide a readable identification code with high stability. In such proposed technologies, after an image is formed on a medium, the contrast between a marking area and a non-marking area on the image is read, and the information that is indicated by an identification code is modified depending on the brightness and darkness.

However, in the above-described proposed technologies, there may be some cases in which the number of image forming operations increases and thus the productivity deteriorates. For example, in order to modify the information represented by the identification code through the entire range of the formed image, it is necessary to reform the entire image again, and the length of time it takes to form an image is at least doubled. Accordingly, there is room for improvement in stably forming an image including, for example, an identification code with high productivity.

In the present embodiment, the laser beam source 101 that emits the pulsed laser beam 101L, the forming unit 201 that makes the pulsed laser beam 101L perform marking on the PET bottle 11c that serves as a container and has transparency and is colorless or colored, and the adjuster 202 that adjusts the marking condition according to the information about the to-be-contained object stored in the PET bottle 11c are provided.

For example, when the to-be-contained object stored in the PET bottle 11c have a bright color, the difference between the brightness of the marking area 231 in the image formed on the PET bottle 11c and the brightness of the to-be-contained object that has passed through the multiple non-nut king areas 232 may become small, and the contrast may be reduced.

In the present embodiment, the marking condition is adjusted according to the color of the to-be-contained object, which is one of the multiple items of information about the to-be-contained object. For example, the marking condition is adjusted such that the brightness of the marking area 231 will further be brighter than the brightness of the to-be-contained object through the multiple non-marking areas 232. Due to such a configuration, high contrast of the image can be ensured.

As the image is not corrected, a decrease in productivity, which may require to form an entire image again, can be prevented. As a result, an image can be stably formed on the PET bottle 11c with high productivity. In other words, an image can be stably formed on the PET bottle 11c with high productivity while securing high contrast of the image.

As known in the art, PET bottles are used in a wide range of applications because the PET bottles have various kinds of desirable functionality such as good preservability and good hermeticity. However, currently, environmental problems such as plastic wastes in the ocean associated with an increase in the amount of plastics used are widely discussed, and there has been a global active movement to reduce the environmental pollution caused by plastic wastes.

PET bottles are no exception. Recycling for environmental protection has been advanced, and after the to-be-contained object is consumed a consumer, the PET bottles are collected and recycled. In particular, circulation recycling so-called bottle-to-bottle recycling is promoted for the PET bottles for beverages.

In the circulation recycling of PET bottles, used PET bottles are separated and collected, and are returned to the material of the PET bottles in the recycling process. Finally, new PET bottles are manufactured again from the material obtained as above. In order to smoothly advance the circulation recycling, the PET bottles need to be separated and collected with great thoroughness.

For the sake of management and sales promotion, labels are pasted onto PET bottles for beverages, but the materials of the base material of the PET bottle and the materials of the labels tend to be different from each other. For this reason, it is desired that the base material and the label be separated from each other in the processes of recycling. For this reason, consumers are required to manually peel off and separate the labels from the bottles on a one-by-one basis at the time of collection, but such manual operation causes an inconvenience.

Currently, labelless PET bottle beverages are being sold. In order to achieve such labelless PET bottles, a method in which information is displayed on a small seal that is pasted onto a PET bottle, or a method in which minimum necessary information is embossed on the base material of a PET bottle and an identification code such as a bar code or the nutrition facts are printed on a box in which a plurality of PET bottles are packaged is adopted.

However, the method in which information is displayed on a small seal may require a cost that correlates with the number of seals. Further, the method in which an identification code is printed on a box is applicable only to box selling is supported, and such introduction is limited.

On such a label, for example, information to be viewed by a consumer such as a product name, nutrition facts, a best before date, a bar code, a two-dimensional code such as a quick response (QR) code (registered trademark), a recycle mark, or a logo mark, and a designed image or an illustration used to appeal features of the product to a consumer are displayed.

If, for example, an image that includes such information can be formed on the base material of the PET bottle, the cost can be reduced, and the PET bottle can be made labelless without restrictions on the sales route.

As a method of forming an image on the base material of a PET bottle, for example, a coloring material such as ink may be applied thereto. However, the applied coloring material may remain as an impurity until a recycling process after the PET bottles are collected. In the process of distribution, management information of a PET bottle may be lost. Accordingly, the recyclability needs to be ensured when an image is formed on a PET bottle.

In the present embodiment, as an image can be stably formed on the PET bottle 11c with high productivity, a labelless PET bottle can be stably manufactured with high productivity. As a result, the labelless PET bottle can be further promoted, and the circulation-type recycling of the PET bottle can be more smoothly performed.

Further, in the present embodiment, the information about the to-be-contained object includes at least one of the spectral characteristics of the to-be-contained object or the amount of filling material of the to-be-contained object.

By adjusting the marking condition according to the spectral characteristics of the to-be-contained object, the brightness of the marking area 231 can be adjusted even when the difference between the brightness of the multiple non-marking areas 232 and the brightness of the marking area 231 becomes small due to the color of the to-be-contained object. Due to such a configuration, the contrast of the image can desirably be ensured.

Depending on the amount of filling material such as the amount of to-be-contained object, the background of the image may be either one of the air or the to-be-contained object. As the brightness of the multiple non-marking areas 232 in the image is different between the air and the to-be-contained object, there are some cases in which the contrast of the image cannot be ensured when the difference in brightness between the marking area 231 and the multiple non-marking areas 232 is small.

By adjusting the marking condition according to the amount of filling material of the to-be-contained object, the brightness of the marking area 231 can be adjusted according to the brightness of the background of the image. Due to such a configuration, the contrast of the image can desirably be ensured.

In the present embodiment, the marking condition includes at least one of the amount of energy of the pulsed laser beam 101L emitted to the PET bottle 11c, the position of the marking on the PET bottle 11c, and the pixel value of the image formed on the PET bottle 11c.

By adjusting the amount of energy of the pulsed laser beam 101L emitted to the PET bottle 11c, the brightness of the marking area 231 can be adjusted according to the to-be-contained object. Due to such a configuration, the contrast of the image can desirably be ensured.

If the marking position includes the boundary between the to-be-contained object and the air in the PET bottle 11c, an error in reading the identification code may occur when the image includes the identification code. By adjusting the marking condition according to the amount of filling material such as the amount of to-be-contained object, the marking position can be adjusted so that the boundary is not included. As a result, the boundary between the to-be-contained object and the air inside the PET bottle 11 can be prevented from being included in the image, and for example, an error in reading the identification code can be prevented.

By adjusting the pixel value of the image formed on the PET bottle 11c, the contrast of the image can be adjusted, and the image can desirably be secured.

As the process is simple, the cost of the medium elm be reduced.

Modifications of Third Embodiment

First Modification of Third Embodiment

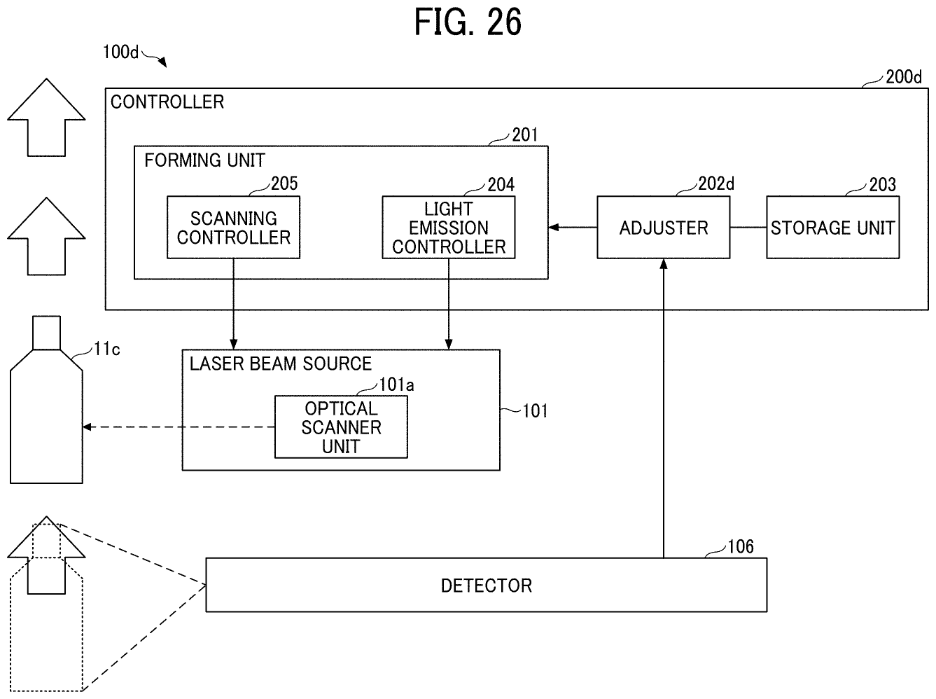

FIG. 26 is a block diagram illustrating a functional configuration of a controller 200d provided for a marking device 100d according to a first modification of the third embodiment of the present disclosure.

As illustrated in FIG. 26, the controller 200d has an adjuster 202d. Further, the marking device 100d includes a detector 106.

Before the marking device 100d performs marking, the detector 106 detects the PET bottle 11c to be carried, and detects the amount of filling material such as the amount of to-be-contained object stored in the PET bottle 11c. The detector 106 includes, for example, a light source, a camera, or a transmission spectrophotometer. Further, the camera of the detector 106 includes, for example, a charge coupled device (CCD) or a complementary metal oxide semiconductor (CMOS) device.

The adjuster 202d adjusts the marking condition according to the amount of filling material such as the amount of to-he-contained object detected by the detector 106.

In the case of forming an image on wide varieties of PET bottles in small lots such as different kinds of products of the same brand in the same manufacturing line, the marking condition is adjusted while detecting the information about the PET bottles and the stored to-be-contained objects in a manufacturing line. Due to such a configuration, the robustness can be improved. FIG. 26 illustrates a configuration in which the marking device 100d includes the detector 106. However, no limitation is indicated thereby, and the detector 106 may be arranged separately from the marking device 100d.

Second Modification of Third Embodiment

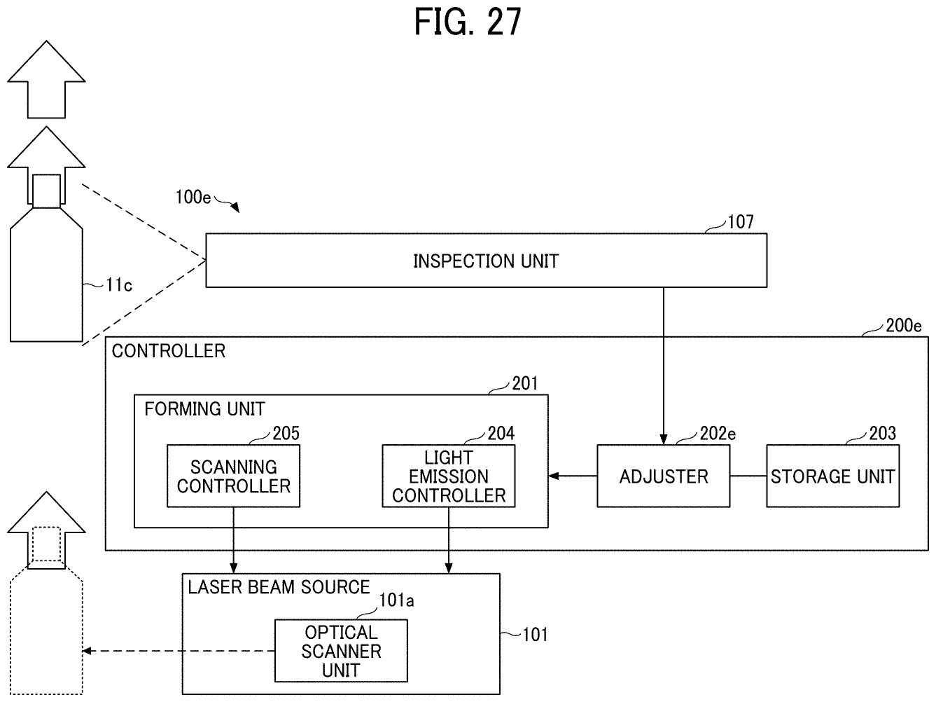

FIG. 27 is a block diagram illustrating a functional configuration of a controller 200e provided for a marking device 100e according to a second modification of the third embodiment of the present disclosure.

As illustrated in FIG. 27, the controller 200e has an adjuster 202e. The marking device 100e includes an inspection unit 107.

The inspection unit 107 inspects the contrast of the image formed on the PET bottle 11c. The inspection unit 107 includes, for example, a light source, a camera, or a transmission spectrophotometer. Further, the camera of the inspection unit 107 includes, for example, a charge coupled device (CCD) or a complementary metal oxide semiconductor (CMOS) device.

The adjuster 202e adjusts the marking condition when a desired contrast is not obtained according to the inspection result of the contrast of the image by the inspection unit 107.

For example, when an image is formed on a PET bottle 11c or a PET bottle 11c of a new product having no information about to-be-contained object, the marking condition is adjusted according to a result of inspection after the image is formed. As a result, the manufacturing line can be operated earlier than when information about the PET bottle 11c or the to-be-contained object is acquired in advance. Although FIG. 27 illustrates a configuration in which the marking device 100e includes the inspection unit 107, the inspection unit 107 may be provided separately from the marking device 100e.

Numerous additional modifications and variations are possible in light of the above teachings. It is therefore to be understood that within the scope of the appended claims, the disclosure of the present disclosure may be practiced otherwise than as specifically described herein. For example, elements and/or features of different illustrative embodiments may be combined with each other and/or substituted for each other within the scope of this disclosure and appended claims.

Embodiments of the present disclosure also includes a method of manufacturing a container. For example, a method of manufacturing a container that includes a design is included. Such a method includes a step of irradiating the container with a laser beam to form a light reflecting layer and a light attenuation layer, the light reflecting layer and the light attenuation layer including an aggregate of a microstructure. In the above step of the method, a condition for formation when the light reflecting layer is to be formed is made different from a condition for formation when the light attenuation layer is to be formed. Accordingly, effects similar to those achieved by the medium according to the above embodiments of the present disclosure as described above can be achieved in the present embodiment of the present disclosure.

The numbers such as ordinal numbers and numerical values that indicates quantity are all given by way of example to describe the technologies to implement the embodiments of the present disclosure, and no limitation is indicated to the numbers given in the above description. The description as to how the elements are related to each other, coupled to each other, or connected to each other are given by way of example to describe the technologies to implement the embodiments of the present disclosure, and how the elements are related to each other, coupled to each other, or connected to each other to implement the functionality in the present disclosure is not limited thereby.

The division of blocks in the functional block diagrams is given by way of example. A plurality of blocks may be implemented as one block, or one block may be divided into a plurality of blocks. Alternatively, some functions may be moved to other blocks. The functions of a plurality of blocks that have similar functions may be processed in parallel or in a time-division manner by a single unit of hardware or software.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-prommmable gate arrays (FPGAs), computers or the like. These terms may be collectively referred to as processors.

Unless specifically stated otherwise, or as is apparent from the discussion, terms such as “processing.” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium comprising an image of design, the design including a light color portion and a dark color portion, the light color portion including a light reflecting layer, and the dark color portion including a attenuation layer.

2. The medium according to claim 1,
wherein the design is formed on a first side of the medium,
wherein the light reflecting layer is formed on a second side of the medium, and
wherein the light reflecting layer reflects a light from the second side to the light color portion of the design.

3. The medium according to claim 1,
wherein the design is formed on a first side of the medium,
wherein the light attenuation layer is formed on a second side of the medium, and
wherein the light attenuation layer attenuates a light traveling from the second side toward the dark color portion of the design.

4. The medium according to claim 1,
wherein the light reflecting layer or the light attenuation layer comprises an aggregate of microstructures, and
wherein the microstructures include at least one of a concave or recesses formed as a part of the medium is melted or evaporated, a crystallized structure formed by crystallizing apart of the medium, or a foamed structure formed as a part of the medium foams.

5. The medium according to claim 1,
wherein at least some of the light reflecting layer and the light attenuation layer overlap each other.

6. The medium according to claim 1,
wherein a difference between a reflectance calculated based on a light reflected by the light color portion and a reflectance calculated based on a light reflected by the dark color portion is equal to or greater than 30%.

7. The medium according to claim 1,
wherein the light attenuation layer includes at least one of an altered layer obtained as a result of alteration of quality of the medium, a layer to which a coloring material is added to the medium, or a layer in which a coloring material is included in a base material of the medium.

8. The medium according to claim 7,
wherein the altered layer is an oxidized layer of the base material of the medium or a carbonized layer of the base material of the medium.

9. The medium according to claim 8,
wherein the medium includes a prism array structure on a surface of the base material of the medium.

10. A container comprising
the medium according to claim 1.

11. A container comprising:
the container according to claim 10; and
a to-be-contained object stored in the container.

12. A marking device comprising:
a laser beam source configured to emit a laser beam;
a forming unit configured to make the laser beam perform marking on a container that has transparency and is colorless or colored; and
an adjuster configured to adjust a marking condition according to information about a to-be-contained object stored in the container.

13. The marking device according to claim 12,
wherein the information about the to-be-contained object includes at least one of a spectral characteristic of the to-be-contained object or an amount of filling material of the to-be-contained object.

14. The marking device. according to claim 12
wherein the marking condition includes at least one of an amount of energy of the laser beam emitted to the container, a pixel value of an image formed on the container, or a position of the marking on the container.

15. The marking device according to claim 12
wherein the forming unit is configured to perform the marking of a design on the container.

16. A method of manufacturing a container including a design, the method comprising
irradiating the container with a laser beam to form a light reflecting layer and a light attenuation layer, the light reflecting layer and the light attenuation layer including an aggregate of microstructures,
wherein, in the irradiating, a condition for formation when the light reflecting layer is to be formed is made different from a condition for formation when the light attenuation layer is to be formed.

17. The method according to claim 16,
wherein the condition for formation includes a focal point of the laser beam.

18. The method according to claim 16,
wherein the irradiating comprises:
irradiating the container with the laser beam to form the light reflecting layer; and
adding a coloring material to the container to form the light a attenuation layer.
